(19) United States
(12) Patent Application Publication
(10) Pub. No.: US 2004/0103112 A1
(43) Pub. Date: May 27, 2004

(54) Computer based method and apparatus for mining and displaying patent data

(76) Inventors: Thomas J. Colson, Buffalo, NY (US); Thomas T. Chronis, Pittsford, NY (US); George B. Osborne III, Maccdon, NY (US)

Correspondence Address: SIMPSON & SIMPSON, PLLC, 5555 MAIN STREET, WILLIAMSVILLE, NY, 14221-5406, US

(21) Appl. No.: 10/713,315

(22) Filed: Nov. 13, 2003

Related U.S. Application Data
(62) Division of application No. 09/415,148, filed on Oct. 8, 1999.

(51) Int. Cl. G06F 17/00

(52) U.S. Cl. 707/102

(57) ABSTRACT

A computer based method and apparatus for mining data from a patent-related document having, a number of independent claims including the steps of analyzing the patent-related document and identifying a section of the document containing claims of the patent-related document and determining which of the claims are independent in nature. The invention also provides a method and apparatus for ranking a set of patents according to strength.

### CROSS-REFERENCE TO RELATED APPLICATIONS

This application is a Divisional of U.S. patent application Ser. No. 09/415,148, incorporated by reference herein.

### REFERENCE TO COMPUTER PROGRAM LISTING/TABLE APPENDIX

In accordance with 37 C.F.R. §1.96, this patent contains a computer software listing in a microfiche appendix. The listing includes 1 microfiche having 44 frames.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all rights under the Copyright Law.

### FIELD OF THE INVENTION

The invention relates generally to patent data mining and analysis tools, and, more specifically to a computer based method and apparatus for mining and displaying patent data.

### BACKGROUND OF THE INVENTION

Intellectual property assets typically make up 60-80% of the value of most companies. Even though revenues from U.S. patents rose from $3 billion in 1960 to $60 billion in 1993, according to the United States Patent and Trademark Office, most traditional companies still don't effectively manage their intellectual property assets, let alone track and analyze the intellectual property assets of their competitors.

Patents usually make up the largest portion of the IP portfolio in any technological company. Companies have always used patents to prevent others from making, using or selling patented products or methods, or to force companies into licensing agreements. There are many good reasons for tracking, mining and analyzing intellectual property data, and particularly patent data. The profitability and growth of some companies is directly related to their ability to develop, defend, and commercialize key patents. Companies who are patent savvy can make more informed decisions about entering new technological areas. They can determine whether certain products warrant patent protection or would infringe the patents of others. They can better predict where their industry, and competitors, is headed. Analyzing patent data is essential in effective negotiation of licenses. It is crucial in determining the true value of a merger or acquisition candidate. It is useful in finding infringers and in identifying licensable technologies. It is useful in finding prior art to invalidate the patents of another. Tracking patents, mining and analyzing patent data in core technologies and businesses, then, is clearly a key strategic priority for many companies. Yet, with over 10 million worldwide patents existing at present (nearly 6 million of which have issued in the United States), and with well over 10,000 new applications for patents filed in an average week, it is exceedingly difficult to track, mine and analyze the enormous volume of available patent data.

Recent software advances have addressed the problem. While private sector companies have offered patent database searching software for years, recently the United States Patent and Trademark Office offered full text searching of patents (and display of images) through its web site at www.uspto.gov. IBM also offers free patent searching through its web site at www.patents.womplex.ibm.com. Most commercially and publicly available software search engines use relatively rudimentary search logic (e.g., Boolean operators, etc.) In 1994, the first natural language patent search engine, MAPIT, was introduced by Manning & Napier Information Services, Inc. of Rochester, N.Y. This powerful product enables one to search the USPTO patent database back to 1971 using natural language phrases. With MAPIT, there is no need to learn or worry about the limitations inherent in Boolean logic. Best of all, the software intelligently ranks the patents found in the search according to relevance, and offers flexibility for the user to modify the contours of the search.

Patent searching for patentability, validity, or infringement purposes are but a few types of data mining processes. There are many others. The goal is to first locate the relevant patents, and then to obtain as much tangible quantitative and qualitative information as possible about them.

Quantitative measurements include data such as the number of patents held by companies in selected technology areas. They also include patenting trends extrapolated from the mined data. Quantitative measurements can include counting the number of claims in patents as well.

Others are beginning to recognize and appreciate the need for mining and analyzing patent data. One such company is Aurigen, Inc. of Mountain View, Calif., (formerly known as SmartPatents, Inc.). This company is the assignee of several patents related to data mining of patents, including U.S. Pat. No. 5,799,325 (Rivette et al.) related to a system, method and computer program product for extracting, synchronizing, displaying, navigating and manipulating text and image documents simultaneously in electronic form; U.S. Pat. No. 5,806,079 (Rivette et al.) related to a system, method and computer program product for using intelligent notes to organize, link, and manipulate disparate data objects; U.S. Pat. No. 5,809,318 (Rivette et al.) related to a method and apparatus for synchronization, displaying and manipulating text and image documents; and U.S. Pat. No. 5,845,301 (Rivette et al.) related to a system, method and computer program product for displaying and processing notes containing note segments linked to portions of documents.

Despite advances in quantitative and qualitative methods of patent data mining, much remains to be done, especially with respect to qualitative analysis of patents. One qualitative measurement relates to the “strength” of a patent, which is dependent upon a number of criteria.

One such criterion relates to the claims of the patent. It is well known that the claims define the metes and bounds of an invention. Claims vary in scope, and experienced patent attorneys are routinely asked to read and evaluate the scope of patent claims. Claim scope is a quasi-subjective interpretation, but there are objective measurement criteria as well. For example, in general, the fewer elements in a claim —the broader its scope. The number of words in a claim can also be an indication of scope.

Another qualitative criterion relative to patent claims relates to the type of invention being claimed. Patent attorneys and agents can readily discern the category of statutory subject matter of a patent claim pursuant to 35 U.S.C. §101 (e.g., article of manufacture, machine, composition of matter, process, and improvement). Although these interpretations are intuitive to most experienced patent attorneys, heretofore, no computer software product has been developed to perform this type of qualitative data mining and analysis, and determine the category of statutory subject matter to which a patent relates.

claim structure and scope are but two criteria that determine the “strength” of a patent. Another factor might be how many citations a patent contains to other patents or other patent references. As is well known, each filed patent application is subjected to a prior art search by the Examiner in the Patent Office. In addition, applicants and their attorneys have a duty to disclose to the Patent Office all information known to that individual to be material to patentability of the invention. These prior art references, identified both by the Patent Office and by the applicant and her attorney, and which comprise both patent and non-patent publications, appear on the face of the patent, and sometimes appear in the Background of the Invention section of the patent. The number of patents cited might be an indication of the strength of the patent. For example, a “pioneer patent” directed to a revolutionary invention would typically cite few if any patents or publications. On the contrary, an improvement patent in a crowded art area is likely to cite a large number of other patents and publications, which might indicate a weaker patent.

Another indication of patent strength is the number of patents that cite the patent in question. For example, a pioneer patent is likely to be cited more often than an improvement patent. What is needed, then, is a computer based method and apparatus for mining and displaying patent data, which method and apparatus performs both quantitative and qualitative analysis, interpretation and display. Ideally what is needed is a computer based method and apparatus for performing this analysis on a plurality of patents, with the ability to then rank the patents according to a number of different criterion. What is also needed is a computer based method and apparatus for ranking one group of patent-related documents against another group.

### SUMMARY OF THE INVENTION

The invention broadly comprises a computer based method for analyzing and ranking a set of patents according to strength, comprising analyzing the set of patents by consideration of objective parameter(s) of each patent in the set, the parameter(s) selected from the group consisting of the number of claims within each patent being ranked, the number of independent claims within each patent being ranked, the number of citations to prior publications cited by a patent examiner within each patent being ranked, the number of other patents which contain a citation to a patent being ranked, the number of elements in an independent claim of each patent, the number of elements in an exemplary claim of each said patent, and the number of terms found in both independent and exemplary claims.

It is a general object of the present invention to provide a method and apparatus for analyzing a pool of patents and for determining and displaying a number of objective facts about each patent in the pool, including but not limited to how many independent claims are contained within each patent.

It is another object of the present invention to provide a method and apparatus for analyzing a pool of patents and then ranking the patents in the pool according to strength as determined by either a predetermined formula or a user-modifiable formula.

It is still another object of the present invention to provide a method and apparatus for analyzing a pool or group of patents and then ranking them against another group of patents.

These and other objects and advantages of the present invention will be readily appreciable from the following description of preferred embodiments of the invention and from the accompanying drawings and claims.

### BRIEF DESCRIPTION OF THE DRAWINGS

FIG. 1 is a screen capture illustrating a listing of patents mined using the present invention and displayed in ascending chronological order;

FIG. 2 is a screen capture illustrating a listing of patents mined using the present 20 invention and displayed in descending chronological order;

FIG. 3 is a screen capture illustrating a listing of patents mined using the present invention and displayed in alphabetical order by assignee;

FIG. 4 is a screen capture illustrating a listing of patents mined using the present invention and displayed in alphabetical order by inventor;

FIG. 5 is a screen capture illustrating a listing of patents mined using the present invention and displayed in ascending order by U.S. Class;

FIG. 6 is a screen capture illustrating a listing of patents mined using the present invention and displayed in order by International Class;

FIG. 7 is a screen capture that illustrates how a user would select a category to initiate a new search using the present invention;

FIG. 8 is a screen capture that illustrates how a user would initiate a new search for patents in the “pool” having the keywords “instrument panel” in the title;

FIG. 9 is a screen capture that illustrates the results of a search for patents in the pool containing the keywords “instrument panel” as described with reference to FIG. 8;

FIG. 10 is a screen capture of the full text of U.S. Pat. No. 5,487,558 obtained by clicking on the hyperlink labeled “Full Patent” as shown in the screen capture of FIG. 9;

FIG. 11 is a screen capture of the patents cited in U.S. Pat. No. 5,487,558 obtained by clicking on the hyperlink labeled “Cited Patents” as shown in the screen capture of FIG. 9;

FIG. 12 is a screen capture of the patents that cite U.S. Pat. No. 5,487,558 obtained by clicking on the hyperlink labeled “Citing Patents” as shown in the screen capture of FIG. 9;

FIG. 13 is a screen capture of the Abstract of U.S. Pat. No. 5,487,558 obtained by clicking on the hyperlink labeled “Abstract” as shown in the screen capture of FIG. 9;

FIG. 14 is a screen capture of the claims of U.S. Pat. No. 5,487,558 obtained by clicking on the hyperlink labeled “claims” as shown in the screen capture of FIG. 9;

FIG. 15 is a screen capture of part of the image of the first page of U.S. Pat. No. 5,487,558 obtained by clicking on the hyperlink labeled “Image” as shown in the screen capture of FIG. 9;

FIG. 16 is a screen capture showing a table of patents in a pool, displayed in a “Short” 5 form;

FIG. 17 is a screen capture illustrating the “Filter” function of the invention;

FIG. 18 is a screen capture displaying patents obtained using a U.S. Class filter selection from the choices displayed in FIG. 17;

FIG. 19 is a screen capture that shows a listing of “classy cousins” of a “focus patent” mined and displayed by the present invention, where a “classy cousin” is defined to be a patent that shares the U.S. Class and at least one reference with the “focus patent”;

FIG. 20 is a screen capture that shows both a predetermined “Mapit Strength Formula” and a “User-modifiable Formula” used to rank the mined patents in the pool and also shows a representative ranking of mined patents in descending order according to the Mapit Strength Formula; and,

FIG. 21 is a screen capture similar to that shown in FIG. 20 but arranged to show the representative ranking of mined patents in descending order according to the “User-modifiable Formula”;

FIG. 22 is a screen capture similar to that shown in FIG. 20 but arranged to show the representative ranking of mined patents in descending order according to total number of claims in each ranked patent;

FIG. 23 is a screen capture similar to that shown in FIG. 20 but arranged to show the representative ranking of mined patents in descending order according to total number of independent claims in each ranked patent;

FIG. 24 is a screen capture similar to that shown in FIG. 20 but arranged to show the representative ranking of mined patents in descending order according to total number of citations in other patents in the pool to each ranked patent;

FIG. 25 is a screen capture similar to that shown in FIG. 20 but arranged to show the representative ranking of mined patents in ascending order according to the total number of search terms found in the first claim of each ranked patent;

FIG. 26 is a screen capture similar to that shown in FIG. 20 but arranged to show the representative ranking of mined patents in descending order according to total number of search terms found in the exemplary claim of each ranked patent;

FIG. 27 is a screen capture similar to that shown in FIG. 20 but arranged to show the representative ranking of mined patents in descending order according to total number of elements in the first claim of each ranked patent;

FIG. 28 is a screen capture similar to that shown in FIG. 20 but arranged to show the representative ranking of mined patents in descending order according to total number of elements in the exemplary claim of each ranked patent;

FIG. 29 is a screen capture illustrating a list of patents mined using the present invention, and also showing a drop-down box whereby a user can select an American or European “short-form” date representation or a long-form date representation;

FIG. 30 is a screen capture illustrating a list of patents arranged in ascending (earliest to latest) chronological order by issue date, where both the application date and issue date are displayed in a long-form format;

FIG. 31 is a screen capture illustrating the “My List” function of the present invention, where a user may place selected mined patents in a special folder labeled “My List” for future reference and analysis;

FIG. 32 depicts a representative client personal computer in communication with a network and operatively arranged to implement the computer program of the present invention.

### DETAILED DESCRIPTION OF THE PREFERRED EMBODIMENT

At the outset, it should be appreciated that the present invention comprises a computer-based method for mining patent data, although the concepts of the invention could obviously be used for mining non-patent data as well. Moreover, the present invention can mine and analyze patent data from any suitable “pool” of patents. The pool may comprise one or more patents. They may be domestic (i.e., United States) or foreign patents. The pool may include patents that have been sorted or filtered (e.g., as by assignee, inventor, etc.) or may be unsorted. Although the present invention is particularly well suited for mining and analyzing patent data associated with a patent portfolio of a particular company, or assignee, the invention is not so limited. For example, the invention could be used to mine and analyze industry-specific patents; or patents in the name of a particular inventor. It could also be used to analyze the portfolio of a patent holding company. A particular advantage of the present invention is its ability to rank a set of patents according to strength, both against one another within the set, and also as a group against another group of patents. In the description of the preferred embodiment, we describe use of the invention in mining and analyzing patent data associated with a particular assignee, but the invention is not so limited.

Although the preferred embodiment described herein illustrates use of the invention with a pool of United States Patents, obviously the technology of the invention could be used to mine data from foreign patents, utility models, inventor's certificates, industrial designs, design patents, patent applications, or any other comparable form of legal protection for intellectual property. In fact, the technology could be used to mine data from non-patent documents. In the description which follows, the terms “patent” and “patent-related document” are intended to include all of the above-recited types of documents related to the legal protection of intellectual property.

In the drawings and written description of the invention, we utilize screen captures taken while operating the software to illustrate the best mode of the invention known to the inventors at the time of application for patent, and to enable those having ordinary skill in the art to use the invention. We also include a microfiche appendix containing the source code for the computer program of the invention to enable one having ordinary skill in the art to make the invention. The software of the present invention is operatively arranged to operate with a conventional web browser, such as those commercially available from Netscape or Microsoft Corporation.

Adverting now to the drawings, we begin our description with an assumption that a patent search has already been conducted to identify a pool of patents for study, mining, and analysis. The pool of patents can be assembled using any number of tools. For example, one can use the commercially available MAPIT™ search tool to identify a group of patents for study, or any other suitable tool (such as the USPTO web site, for example). In the drawing figures, a patent search was completed to identify certain patents assigned to a common assignee (Mercedes-Benz). The raw electronic patent data used to represent the pool is available directly from the USPTO or from third party vendors.

In the description that follows, the term “Exemplary claim” is defined to be a claim in a United States patent determined by the Patent Office to be exemplary of the invention. In practice, this “exemplary claim” is determined by the Examiner who examined the application which matured in the patent. The exemplary claim, which is also published in the Official Gazette, is determined in accordance with Section 1302.09 of the Manual of Patent Examining Procedure as follows:

Examiners, when preparing an application for issue, are to record the number of the claim selected for printing in the Official Gazette in the box labeled “PRINT CLAIM” on the face of the file wrapper.

The claim or claims should be selected in accordance with the following instructions:

(A) The broadest claim should be selected.

(B) Examiners should ordinarily designate but one claim on each invention, although when a plurality of inventions are claimed in an application, additional claims up to a maximum of five may be designated for publication.

(C) A dependent claim should not be selected unless the independent claim on which it depends is also printed. In the case where a multiple dependent claim is selected, the entire chain of claims for one embodiment should be listed.

(D) In reissue applications, the broadest claim with changes or the broadest additional reissue claim should be selected for printing.

M.P.E.P. §1302.9 (Notations on File Wrapper) July 1998

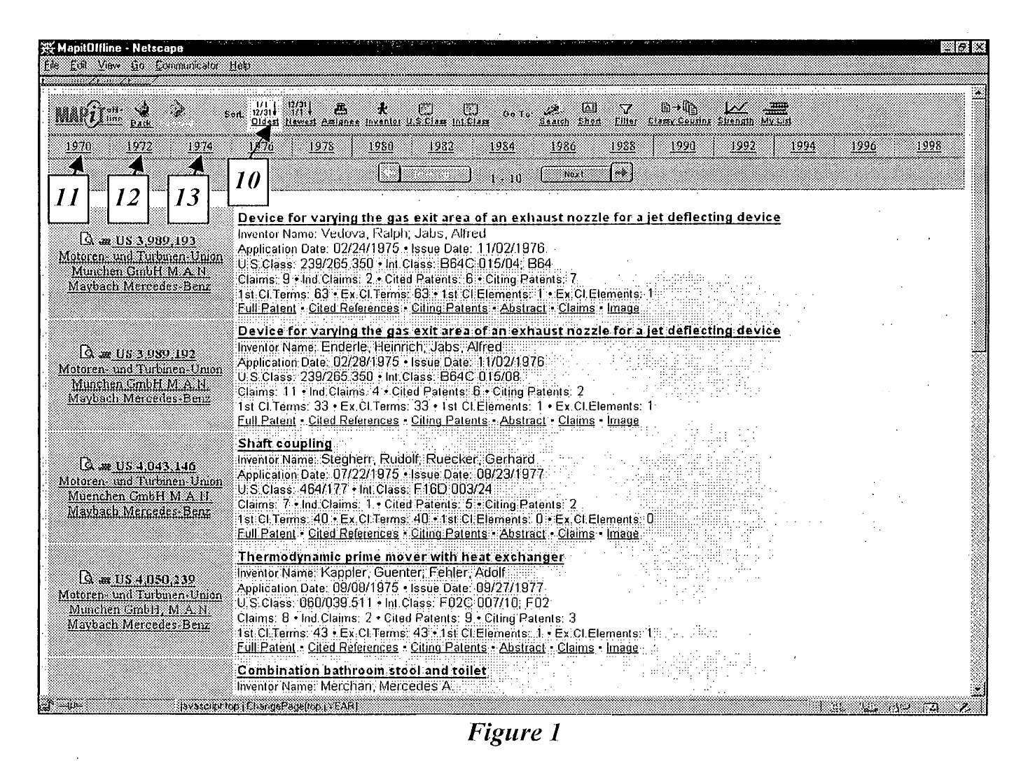

Once a pool of patents has been assembled, the invention is capable of sorting the patents in a number of different ways. As shown in the screen capture of FIG. 1 (to the right of the word “Sort”), the program can sort in ascending chronological order (labeled “Oldest”), descending chronological order (labeled “Newest”), by Assignee, Inventor, U.S. Class, or International Class.

In FIG. 1, the patents are displayed in ascending chronological order (earliest to latest). This is accomplished by clicking on hyperlink 10. The screen capture of FIG. 1 shows complete data for only four patents, U.S. Pat. Nos. 3,989,193 (the patent number is hidden by reference boxes 11, 12 and 13); 3,989,192; 4,043,146 and 4,050,239. The ascending chronological sort tool 10 of the invention (labeled “Oldest” to the fight of the word “Sort” on the screen) lists the patents in chronological order according to issue date. In the listing shown in the screen capture of FIG. 1, the American date format (mm/dd/yyyy) is used, although the date format is settable by the user. Further chronological sorting of the list shown in FIG. 1 can be done using individual year tools 11, 12, 13, etc. For example, clicking on tool 12 would result in a list of patents that issued in 1972.

The program of the invention is capable of mining and displaying extensive information about each individual patent in the pool, as well as performing a ranking of a group of patents (discussed infra). For example, in FIG. 1, four patents are identified. For convenience, we discuss only U.S. Pat. No. 3,989,192 (the patent listed second from the top). As seen in the drawing, the computer program of the invention has analyzed the patent, and displayed various types of information about the patent. Specifically, the program has determined the title of the patent to be DEVICE FOR VARYING THE GAS EXIT AREA OF AN EXHAUST NOZZLE FOR A JET DEFLECTING DEVICE. Two inventors have been identified: Heinrich Enderle and Alfred Jabs. The program also determines the application date (Feb. 28, 1975) and issue date (Nov. 2, 1976). The U.S. and International Classes identified on the face of the patent are identified and displayed. The program counts the total number of claims (11) in the patent, and determines how many of those are independent claims (4). The program then determines how many patents are cited by this patent (“Cited Patents:6”), and how many other patents cite the patent (“Citing Patents:2”). The “Cited Patents” are determined in accordance with Section 1302.12 (Listing of References) in the Manual of Patent Examining Procedure.

The next line lists the number of search terms found in the first claim of the patent (33), in the exemplary claim of the patent (33), the number of elements in the first claim (1) and the number of elements in the exemplary claim (1).

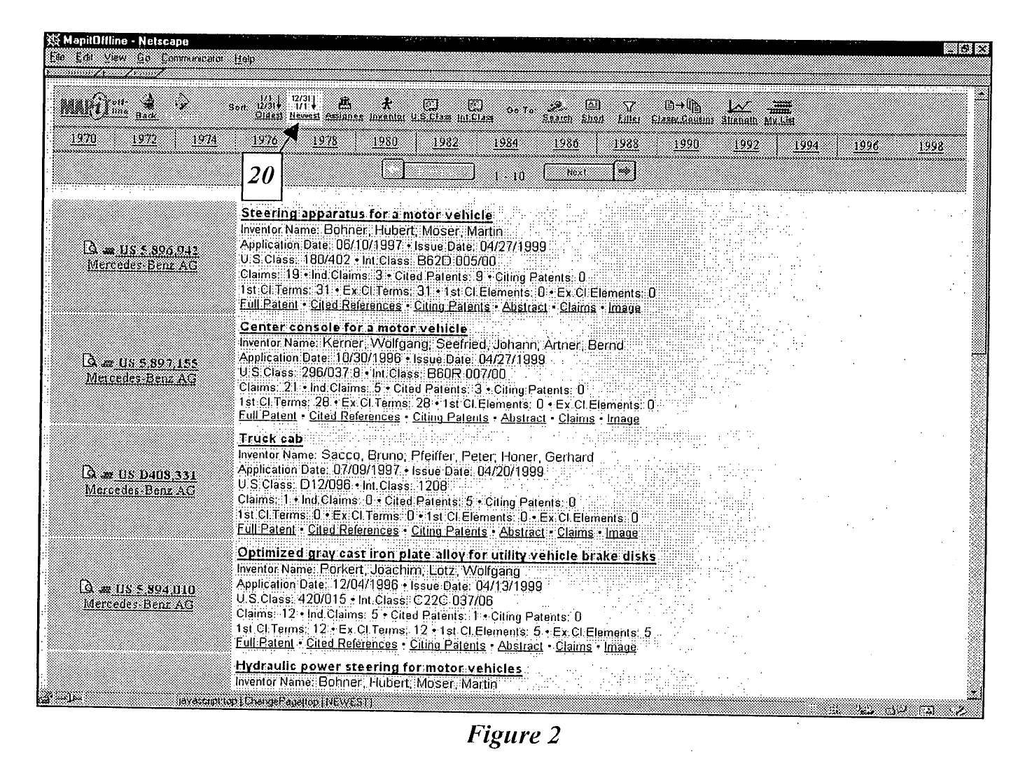

FIG. 2 is a screen capture similar to that of FIG. 1, except showing a listing that results from sorting the patents in descending chronological order by clicking on hyperlink 20.

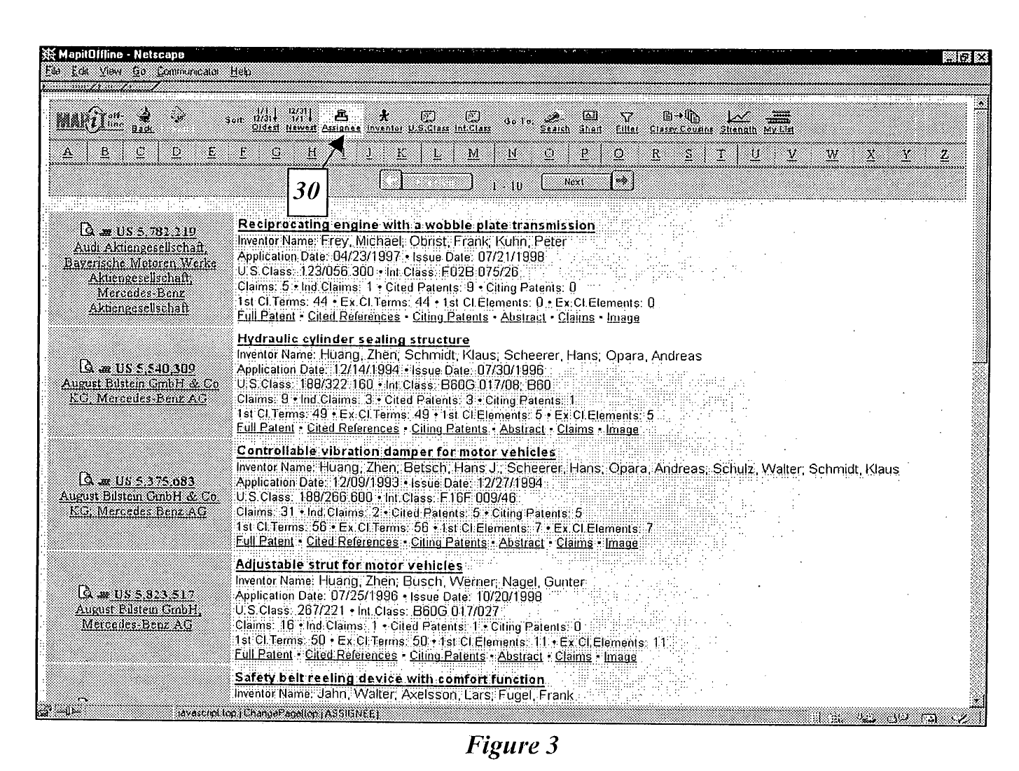

FIG. 3 is a screen capture that shows a listing that results from an assignee sort, achieved by clicking on hyperlink 30. In the screen capture shown, all patents listed include Mercedes-Benz as one of the assignees.

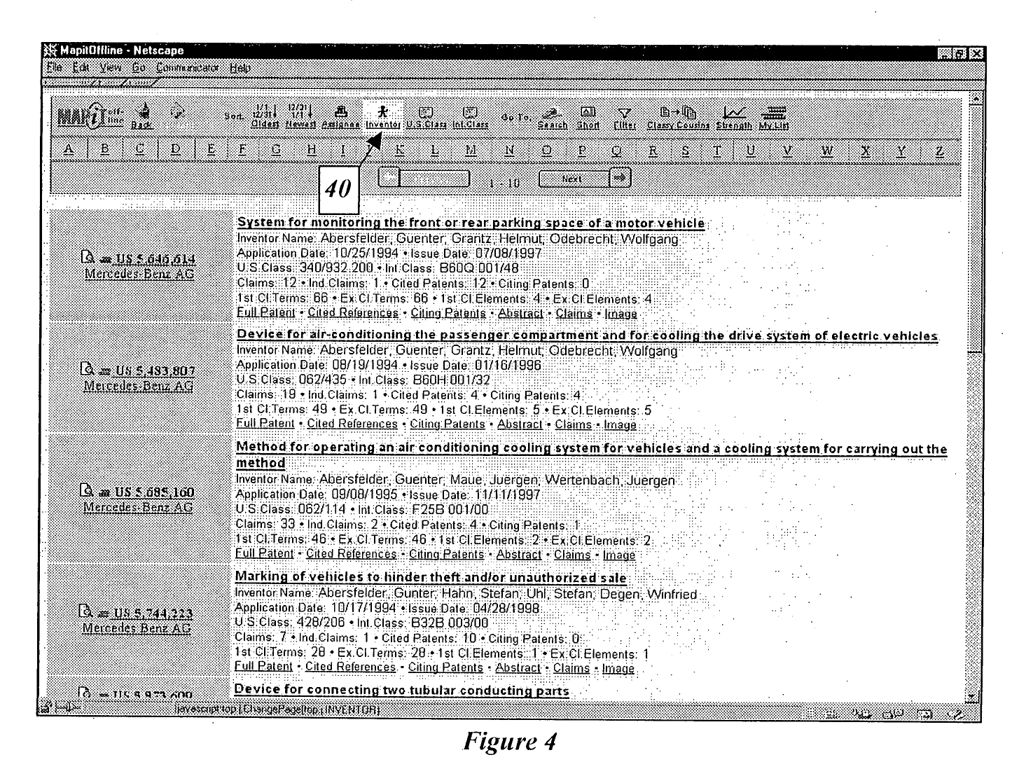

FIG. 4 illustrates the ability of the program to sort patents in the pool by inventor name. The patents are listed in alphabetical order by first listed inventor last name. This sort is achieved by clicking on hyperlink 40. In the screen capture of FIG. 4, the first named inventor of the four patents shown has a last name beginning with the letter “A.”

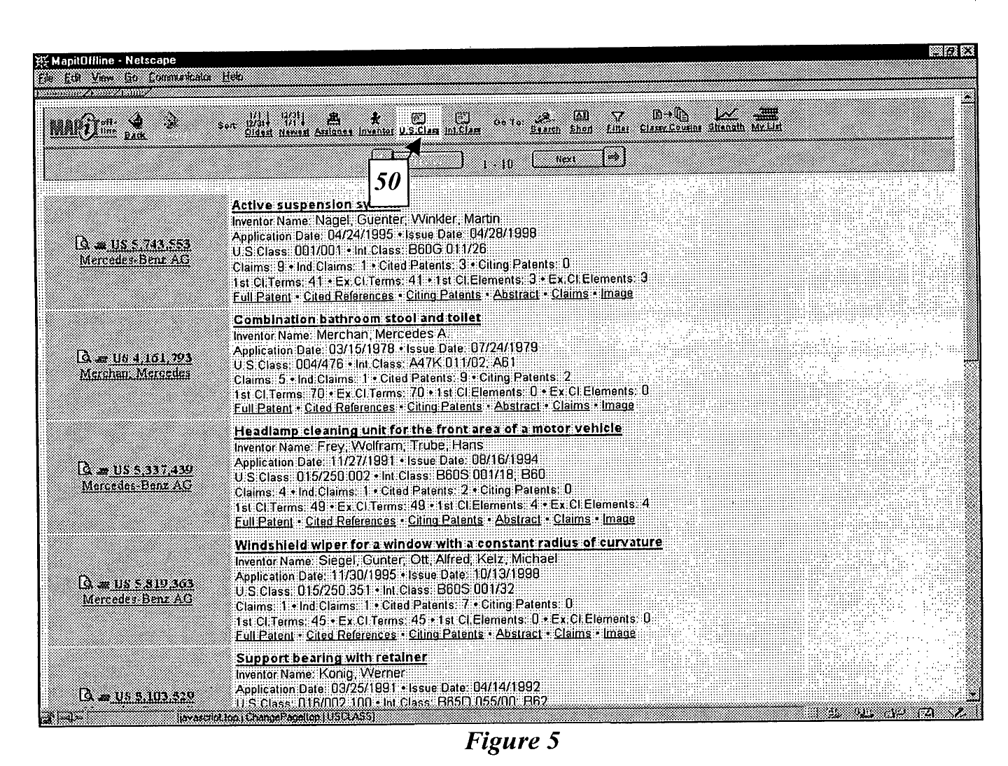

FIG. 5 is a screen capture that shows a listing that results from an ascending 15 sorting by U.S. Class as noted on the face of each patent. This sort is achieved by clicking on hyperlink 50.

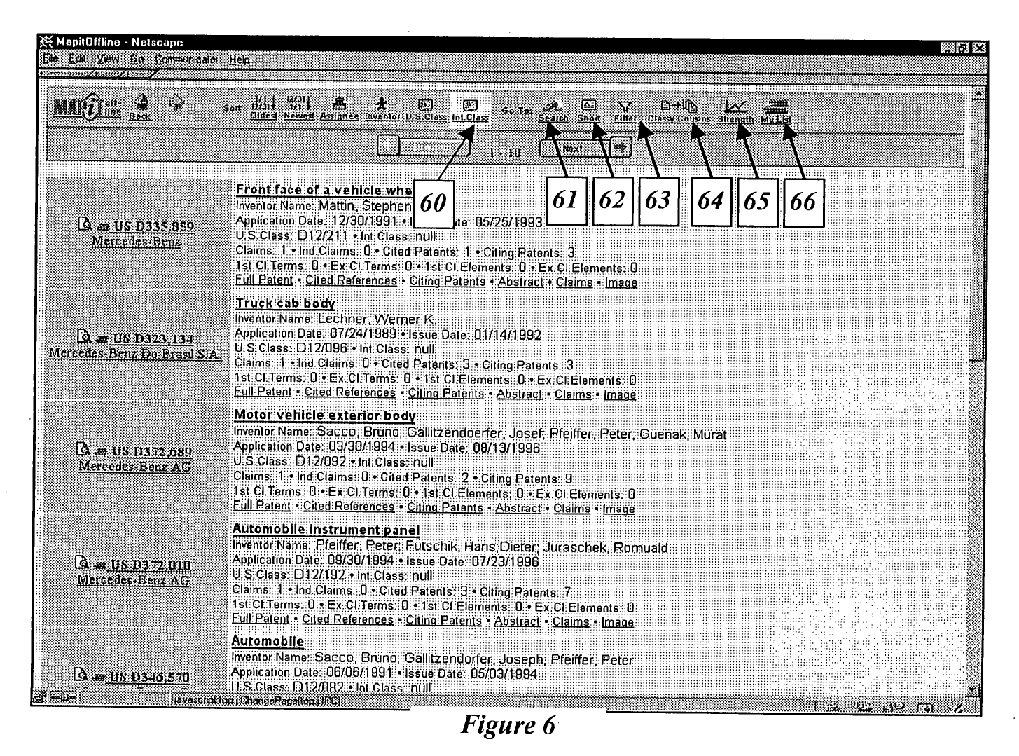

Similar to the screen capture of FIG. 5, the screen capture of FIG. 6 shows a listing that results from a sorting by International Class as noted on the face of each patent. This sort is achieved by clicking on hyperlink 60.

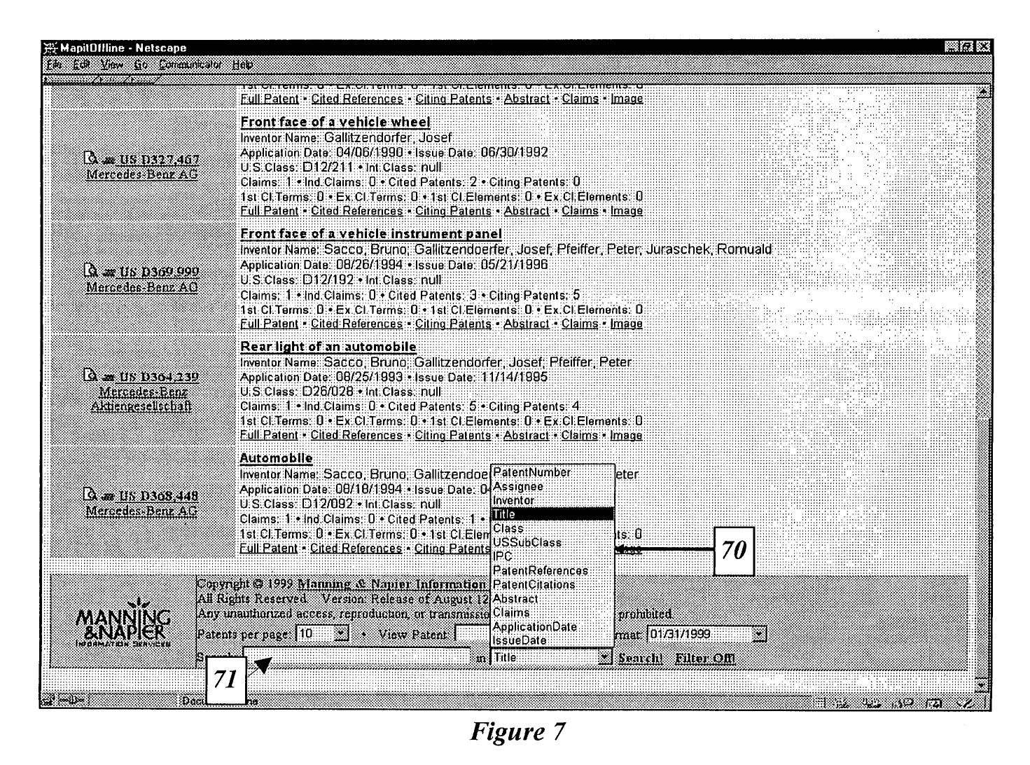

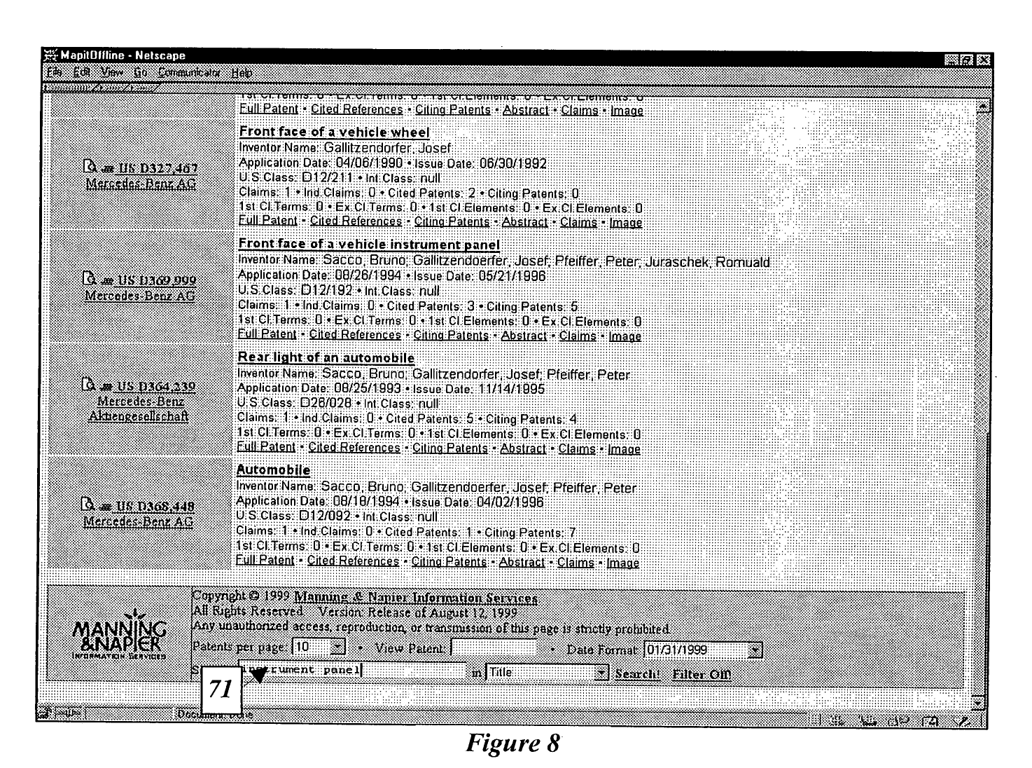

Once a pool of patents has been identified, a user can search the pool for specific patents of interest. As shown in FIG. 7, drop down box 70 recites a number of patent segments that can be searched (PatentNumber, Assignee, Inventor, etc.) The search keywords are entered into box 71, once a patent segment has been selected. In FIG. 8 for example, the keywords “instrument panel” have been entered into search box 71, and the program has been configured to find all patents in the pool that contains those keywords in the title.

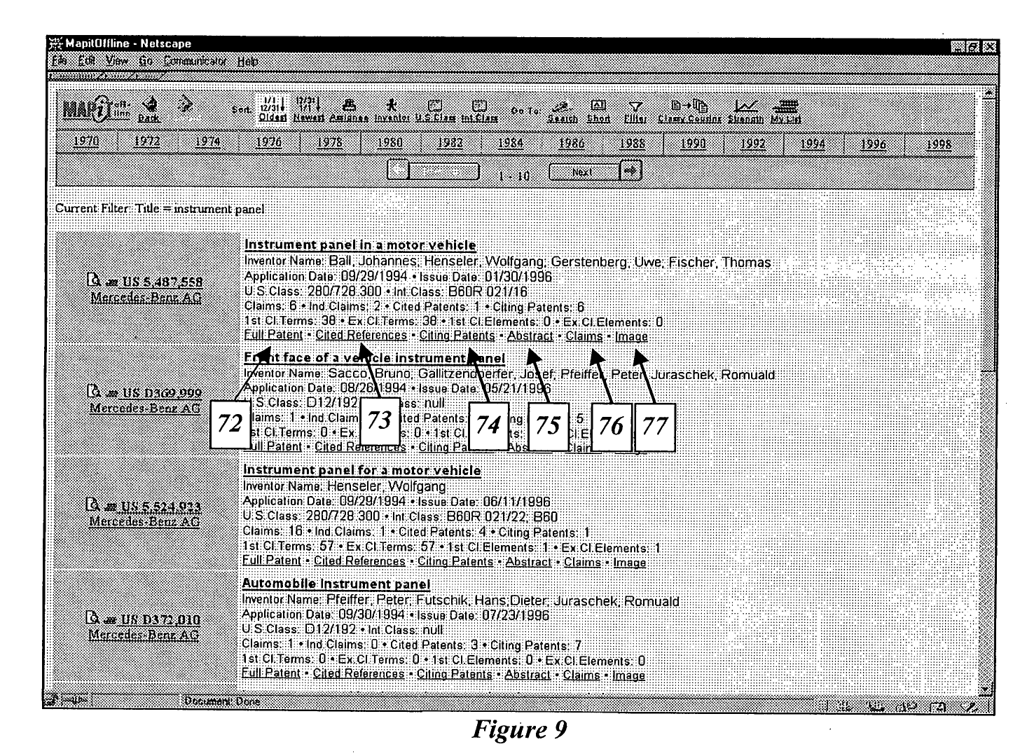

The results of the search for all patents in the pool which contain the keywords “instrument panel” in the title is illustrated in FIG. 9, where four patents of the pool are shown. The first patent in the list is U.S. Pat. No. 5,487,558 for an invention entitled, “INSTRUMENT PANEL IN A MOTOR VEHICLE.” The pertinent information about this patent is shown in a “long form,” although the results of the search could be displayed in a short tabular form as described infra. Further information about the patent can be obtained by clicking on hyperlinks 72-77 as shown in FIG. 9. For example, one can view the full text of the patent by clicking on hyperlink 72 (Full Patent); a list of the patents cited by the patent by clicking on hyperlink 73 (Cited Patents); a list of the patents that cite the patent by clicking on hyperlink 74 (Citing Patents); the abstract of the patent by clicking on hyperlink 75 (Abstract); the claims of the patent by clicking on hyperlink 76 (claims); or the image of the actual patent (including the drawing figures) by clicking on hyperlink 77 (Image).

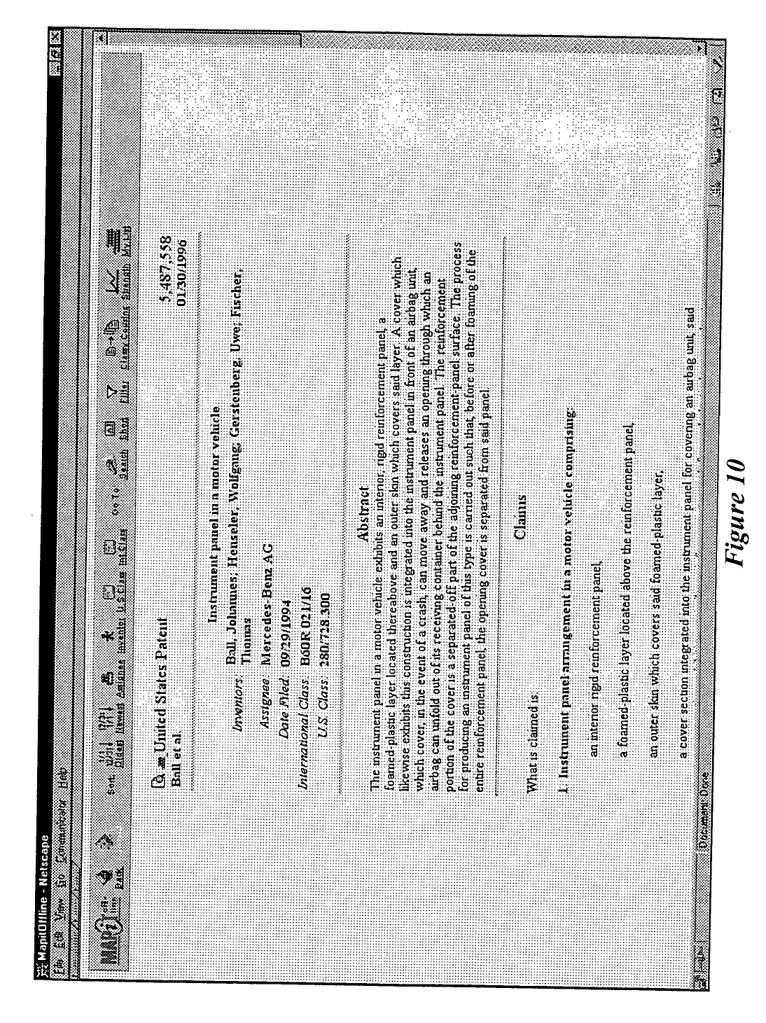

FIG. 10 is a screen capture of the full text of U.S. Pat. No. 5,487,558, obtained by clicking on hyperlink 72 in FIG. 9.

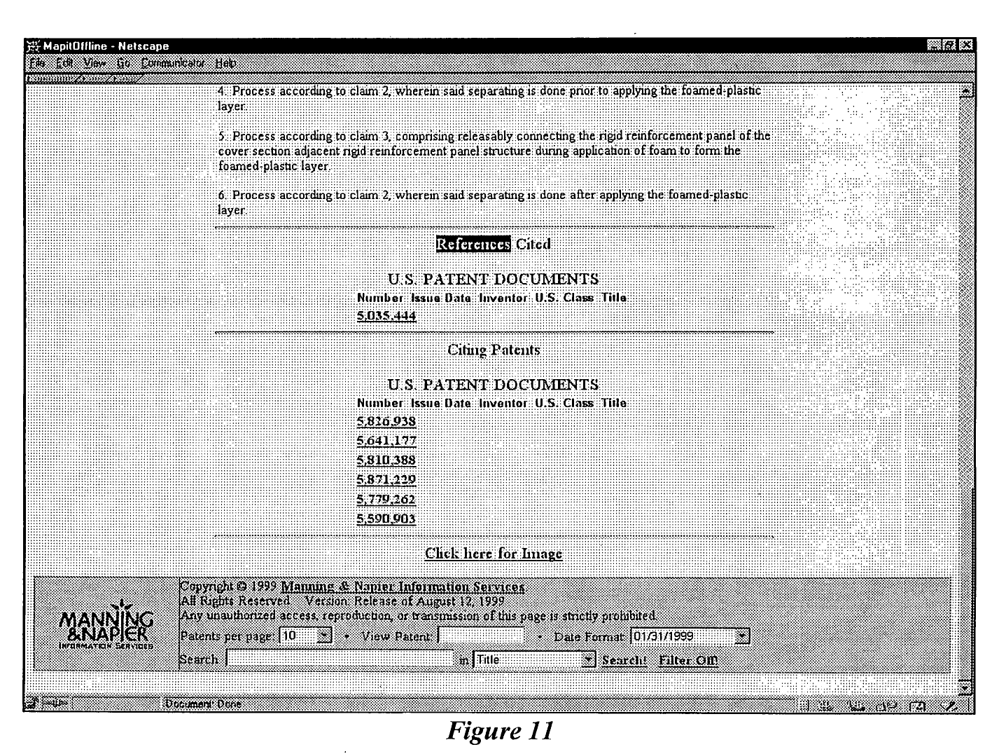

FIG. 11 is a screen capture of the references cited on the face of U.S. Pat. No. 5,487,558, obtained by clicking on hyperlink 73 in FIG. 9.

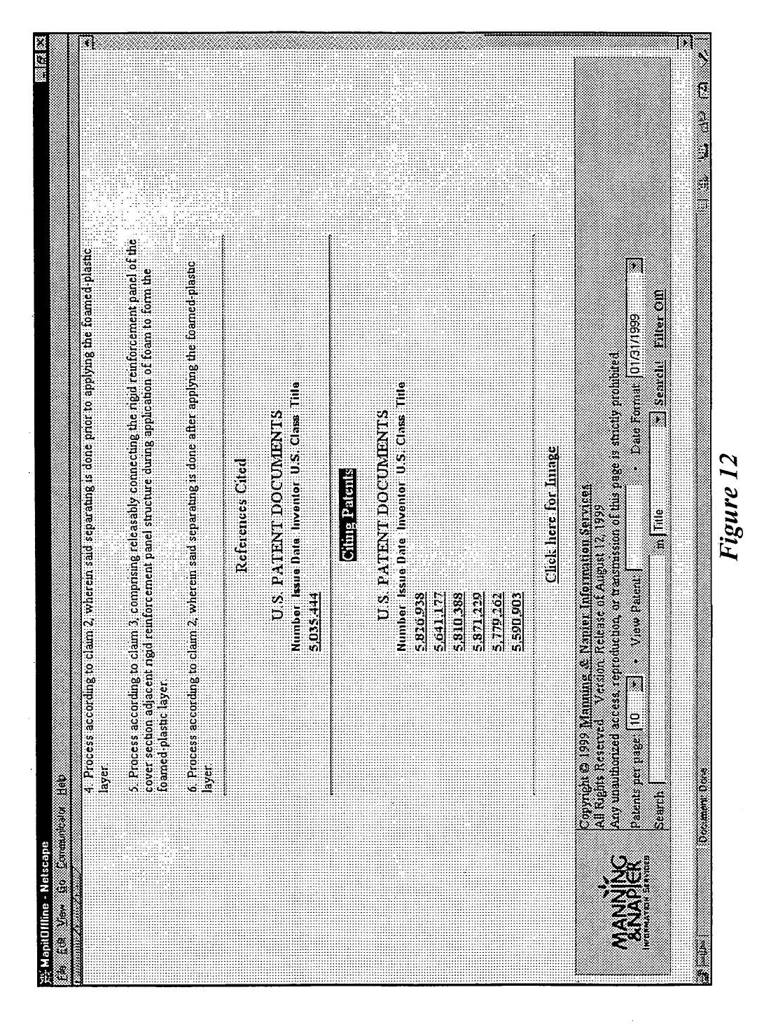

FIG. 12 is a screen capture containing a listing of the patents which cited U.S. Pat. No. 5,487,558, obtained by clicking on hyperlink 74 in FIG. 9.

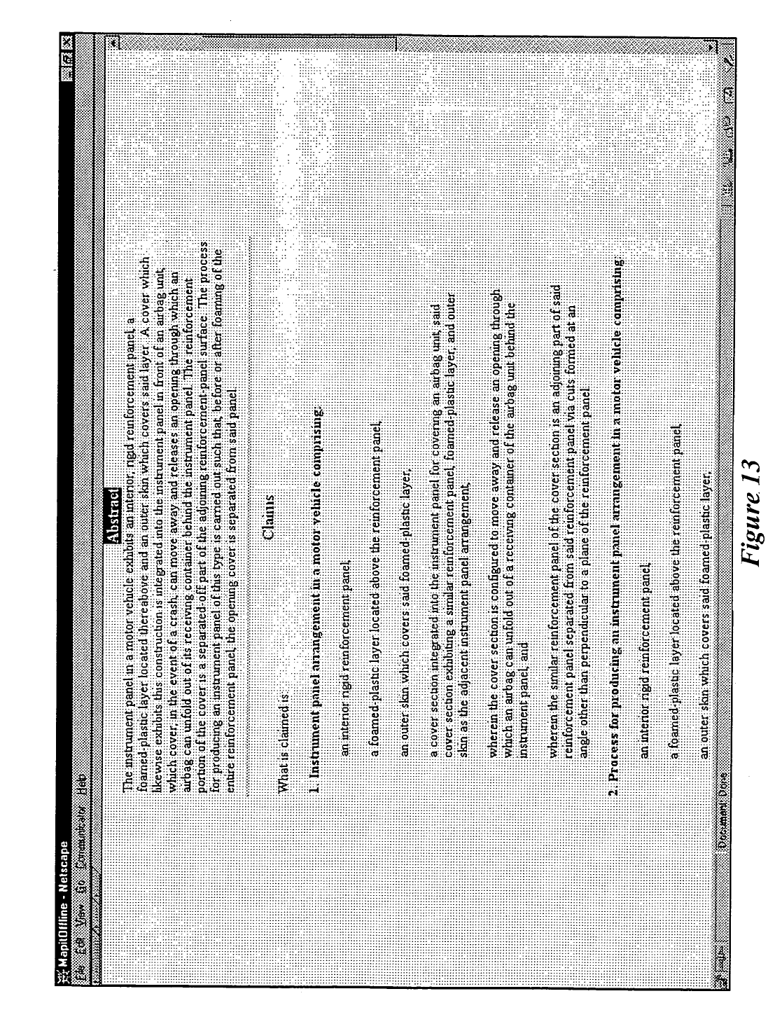

FIG. 13 is a screen capture of the Abstract of U.S. Pat. No. 5,487,558, obtained by clicking on hyperlink 75 in FIG. 9.

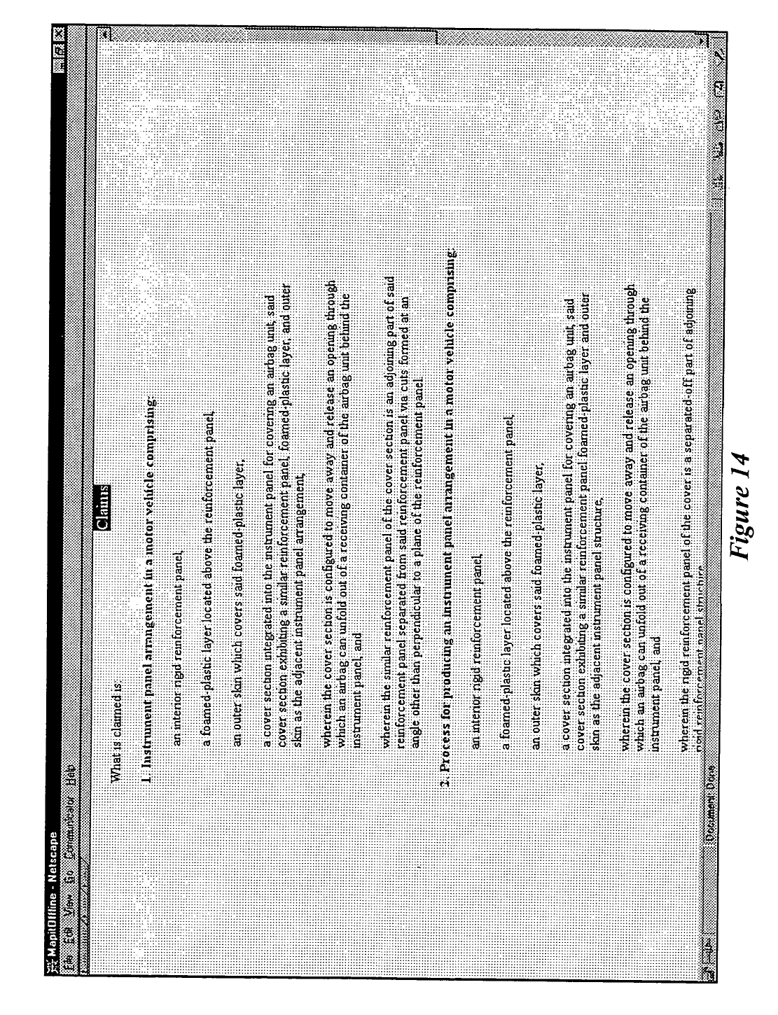

FIG. 14 is a screen capture of the claims of U.S. Pat. No. 5,487,558, obtained by clicking on hyperlink 76 in FIG. 9.

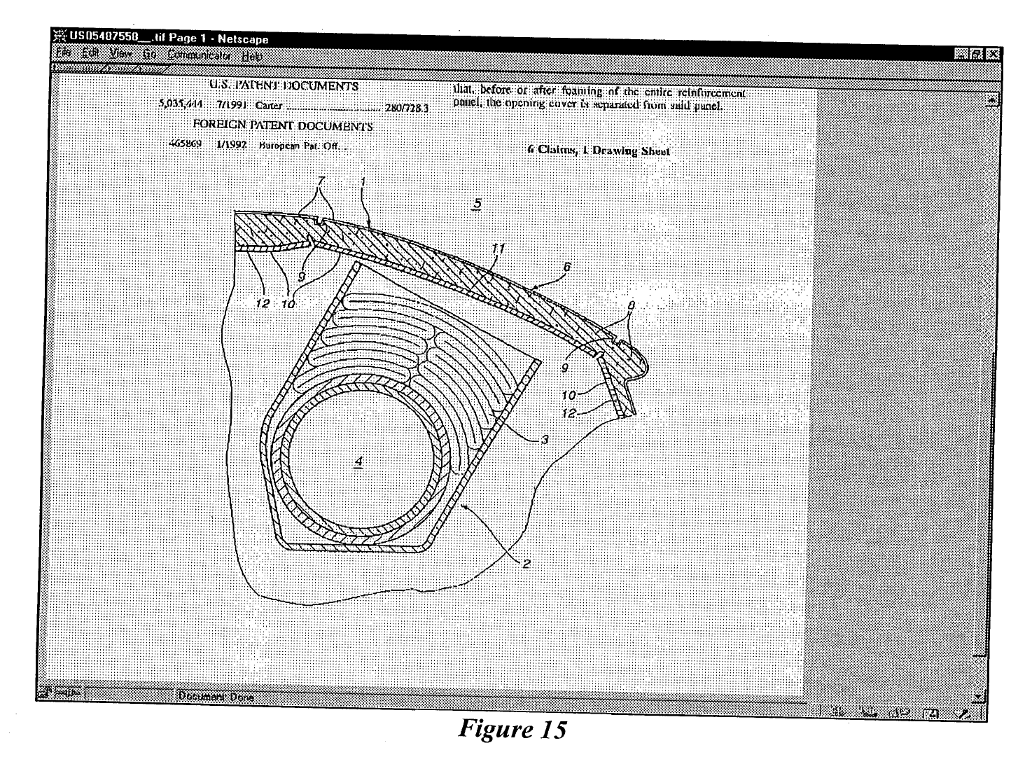

FIG. 15 is a screen capture of the image of U.S. Pat. No. 5,487,558, obtained by clicking on hyperlink 77 in FIG. 9.

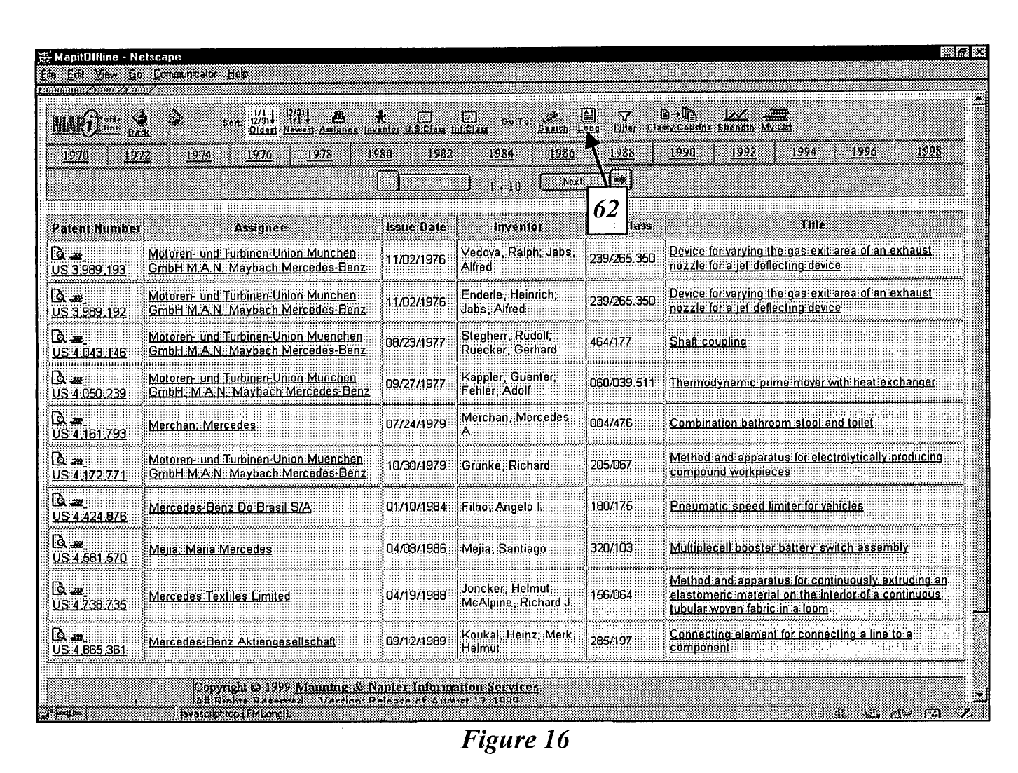

The patents obtained as a result of a data mining operation may be displayed in various formats using the software of the present invention. FIG. 16, for example, displays a “Short Form” listing, which includes tabular columns entitled, “Patent Number,” “Assignee,” “Issue Date,” “Inventor,” “U.S. Class,” and “Title.” Obviously, other column headings are possible, and these headings as well as the number of columns shown are settable by the user.

The type of format is selected by clicking on icon 62 as shown in FIG. 16. For example, while viewing the “Short Form” listing shown in FIG. 16, one could click icon 62 to view a “Long Form” listing.

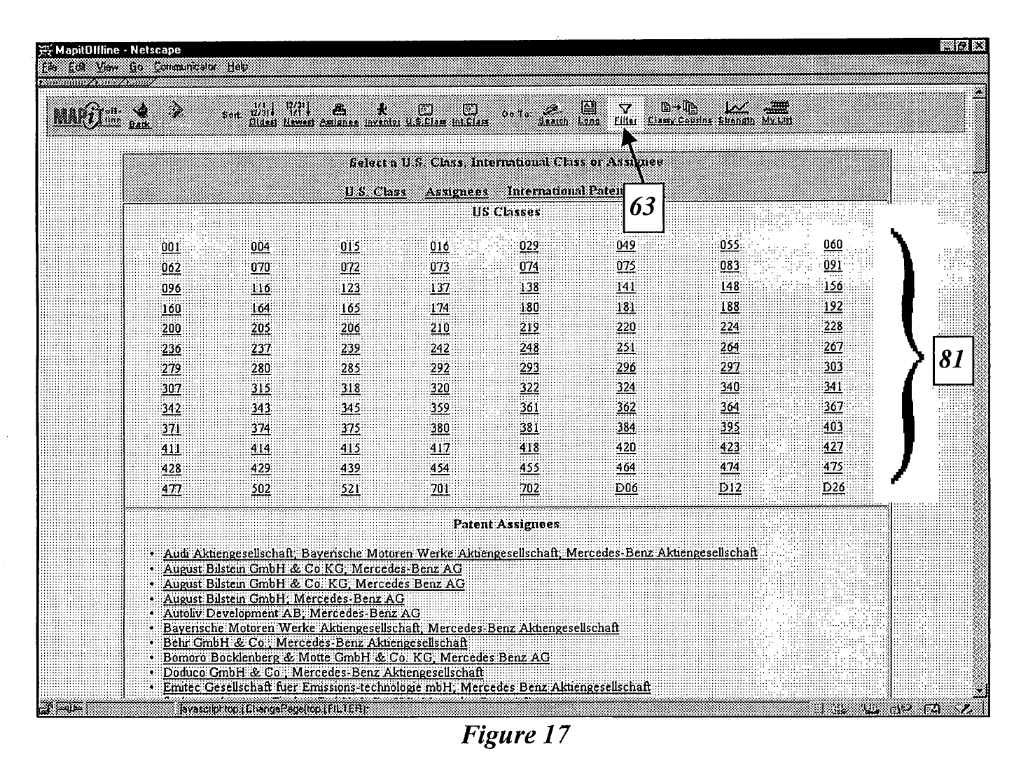

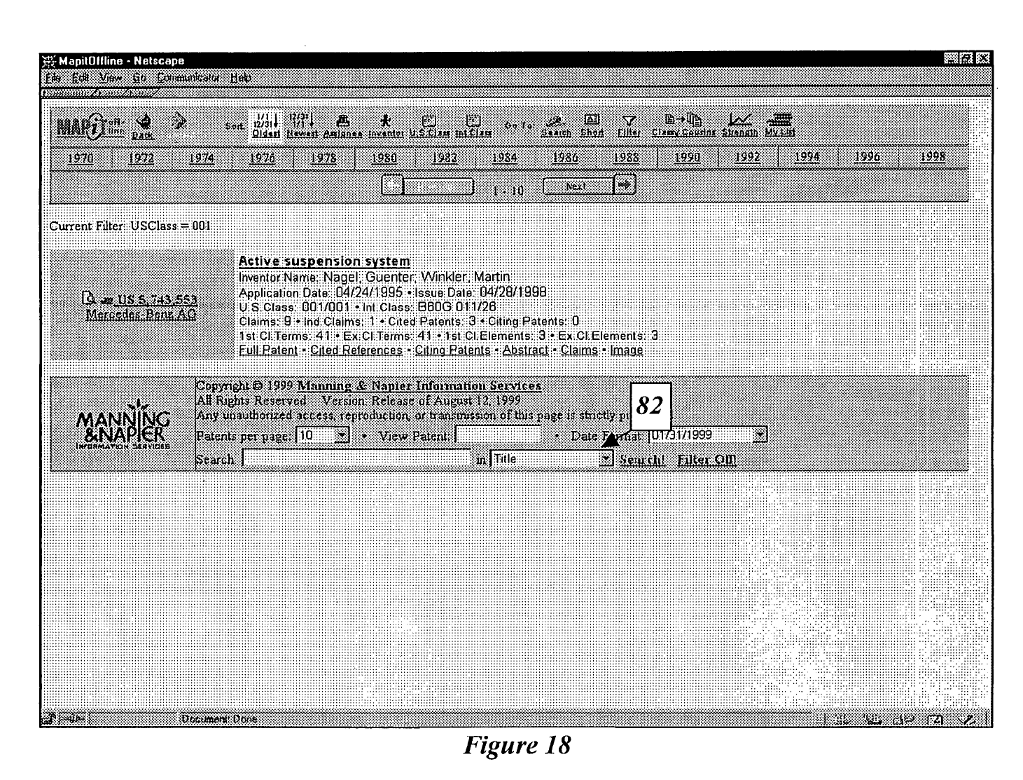

Once a pool of patents has been identified, the program is capable of filtering the pool to focus upon a subset of patents. This is done by clicking on the Filter hyperlink 63 on the main screen. In FIG. 17, for example, the Filter hyperlink has been selected, and the user can filter the pool of patents either by U.S. or International Class, or by Assignee. To select a subset of patents that are all classified in the same class, one would simply click on an appropriate class hyperlink from the list of classes. If one selected U.S. Class 001, for example, a list of patents would be displayed as shown in FIG. 18, where U.S. Pat. No. 5,743,553 is displayed, and this patent is classified in U.S. Class 001.

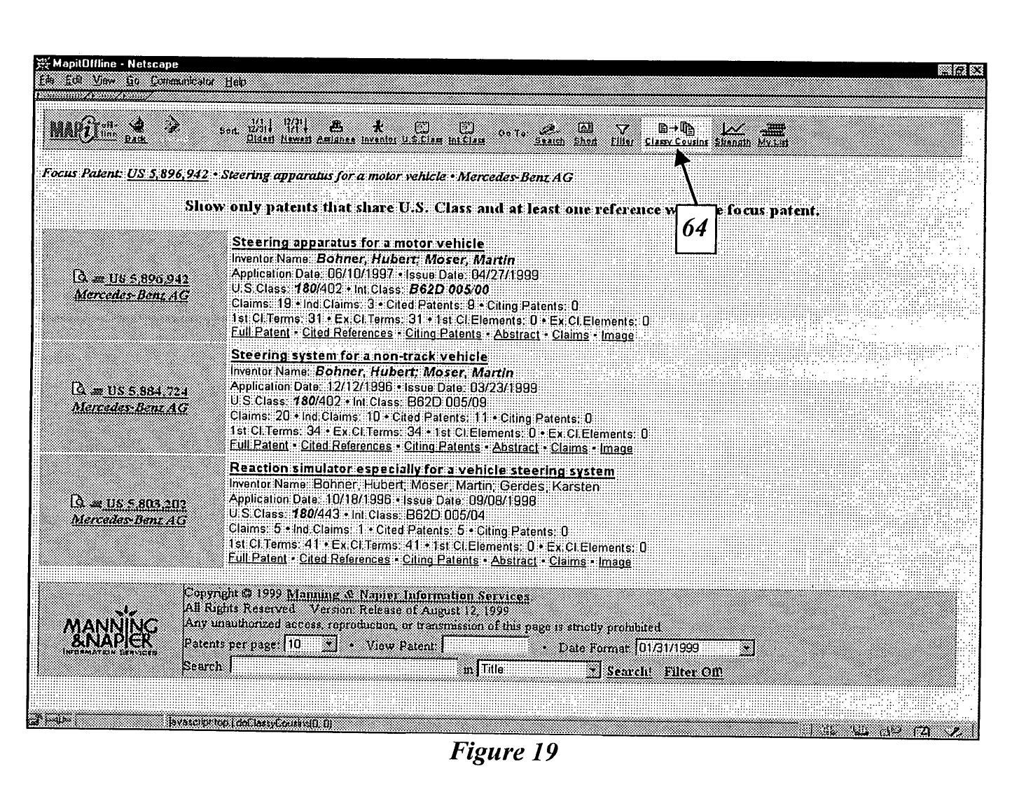

Another data mining tool of the present invention is entitled Classy Cousins, which, again, is selected by clicking on the Classy Cousins hyperlink 64 on the main screen (as shown in FIG. 19). A “Classy Cousin” is defined to be a patent that shares the same U.S. Class and at least one reference cited therein with the focus patent. In other words, if U.S. Pat. No. 5,896,942 is the focus patent, and a user selects the Classy Cousins sort tool, then only those patents in the pool in U.S. Class 180 that cite at least one reference cited on the face of the '942 patent will be selected.

Finally, hyperlinks (identified by underlined text in the screen capture) enable a user to view the full text of the focus patent (Full Patent); a list of the patents cited by the focus patent (Cited Patents); a list of the patents that cite the focus patent (Citing Patents); the abstract of the focus patent (Abstract); the claims of the focus patent (claims); or the digital image of the focus patent (Image).

Once a pool of patents has been identified, perhaps the most useful tool of the present invention is the ranking tool. By clicking on the Strength icon on the main screen (icon 65 shown in FIG. 6) the program can perform an analysis of the patent in the pool and rank the patents according to strength. The metric used to determine strength comprises a weighted formula that includes several factors, including the number of independent claims, the total number of claims, the number of elements in the first claim, the number of elements in the exemplary claim, the number of references cited in the patent, and the number of patents that cite the focus patent. The weighted formula is reprinted herebelow:

Strength Rating=A+(B×Number of claims)+(C×Number Of Independent Claims)+(D×Number of Citations)+(E×Number of First Claim Terms)+(F×Number of Exemplary Claim Terms)+(G×Number of First Claim Elements)+(H×Number of Exemplary Claim Elements)

where,

Number of Claims=total number of claims in patent being evaluated

Number Of Independent Claims=total number of independent claims in patent being evaluated

Number of Citations=number of patents that cite the patent being evaluated

Number of First Claim Terms=number of terms found in first claim of patent being evaluated

Number of Exemplary Claim Terms=number of terms found in exemplary claim of patent being evaluated

Number of First Claim Elements=number of elements in first claim of patent being evaluated

Number of Exemplary Claim Elements=number of elements in exemplary claim of patent being evaluated

Obviously, the “strength” of a patent is a subjective determination. Some attorneys and business people might be of the opinion that a patent with more claims is stronger than a patent with fewer claims. Others may believe that it is the number of elements in the broadest claims which determines strength. On the other hand, a pioneer patent which is cited often by subsequent patents may be “stronger” than a patent with only a few elements in a weak or old technology area. In view of this subjective assessment, the formula of the present invention is preset with various weighted factors, but these weights may be adjusted by the user. The user can set one or more factors to any weight, including negative weights.

In a preferred embodiment, the software calculates the strength of a patent based upon the predetermined formula, where the coefficients are set as follows:

A=1.0

B=4.0

C=8.0

D=−0.1

E=−0.1

F=−0.1

G=−0.1

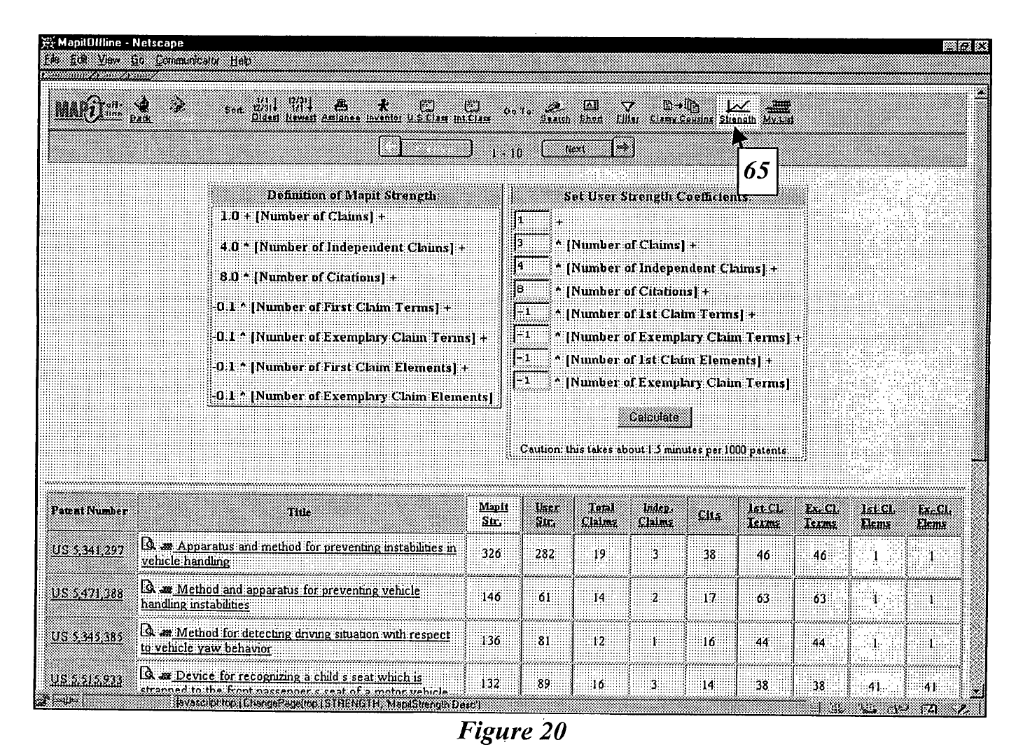

This predetermined formula defines the “Mapit Strength” of the patent, as shown by the formula in FIG. 20 labeled “Definition of Mapit Strength”. FIG. 20 also shows a listing of patents in a pool sorted in descending order of “Mapit Strength.”

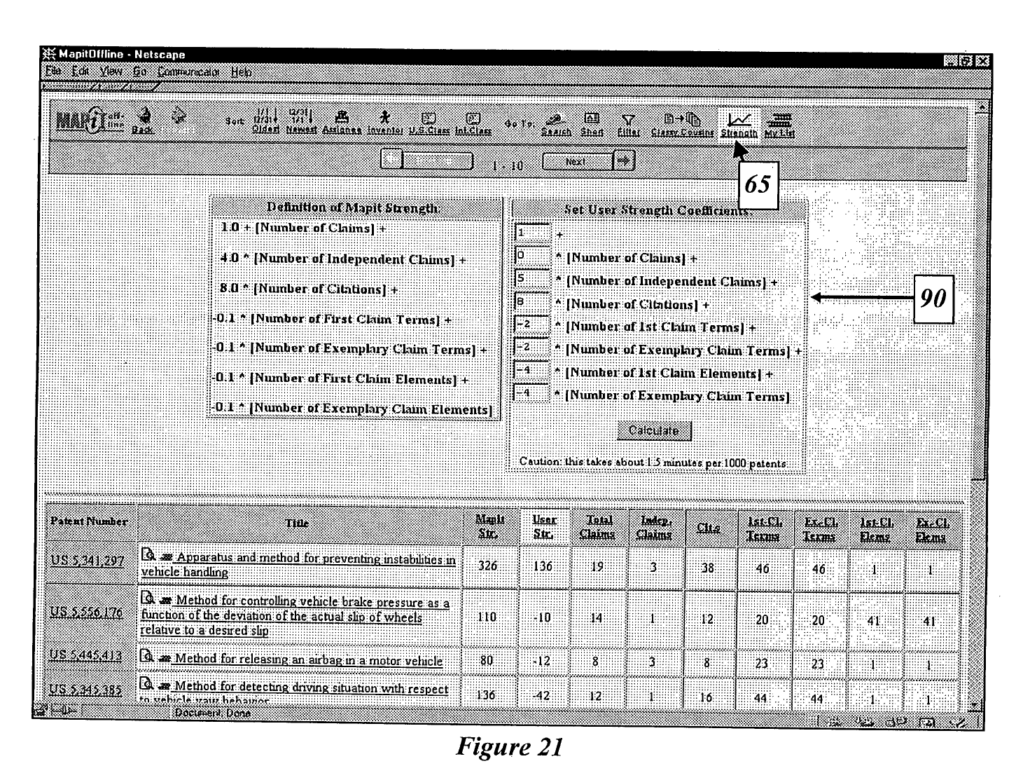

A user-defined formula is shown in box 90 in FIG. 21. In this formula, the user has set the formula coefficients as follows:

A=1.0

B=0.0

C=5.0

D=−2.0

E=−2.0

F=−4.0

G=−4.0

FIG. 21 also shows a listing of patents in a pool sorted in descending order of “User-Defined Strength.”

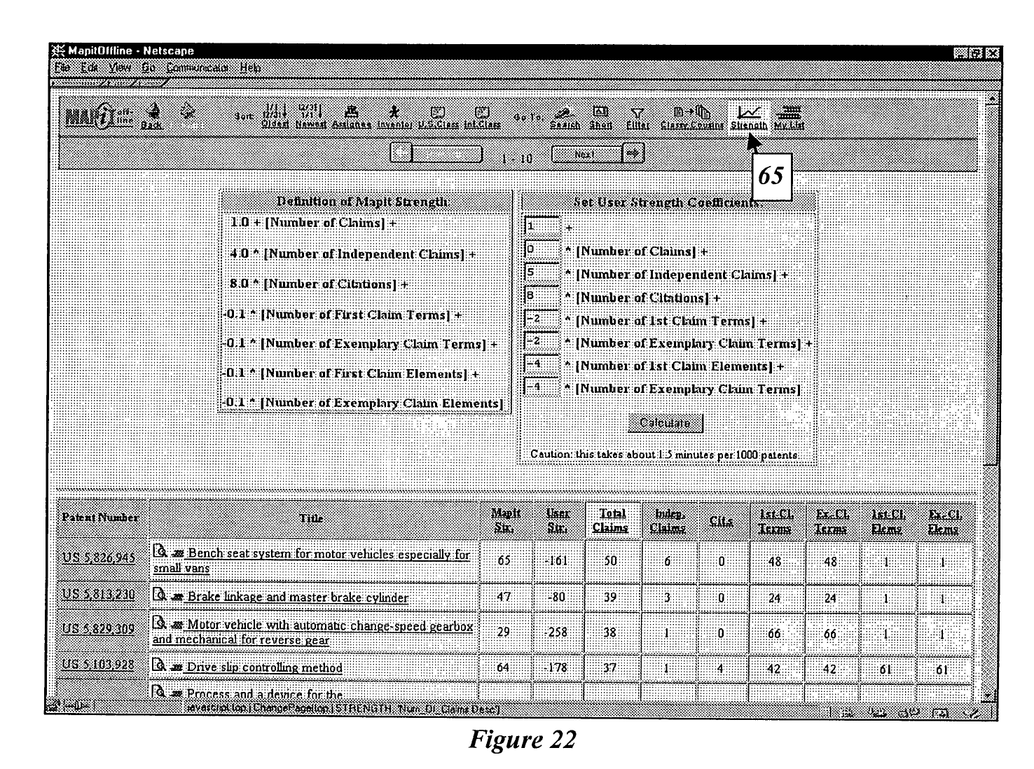

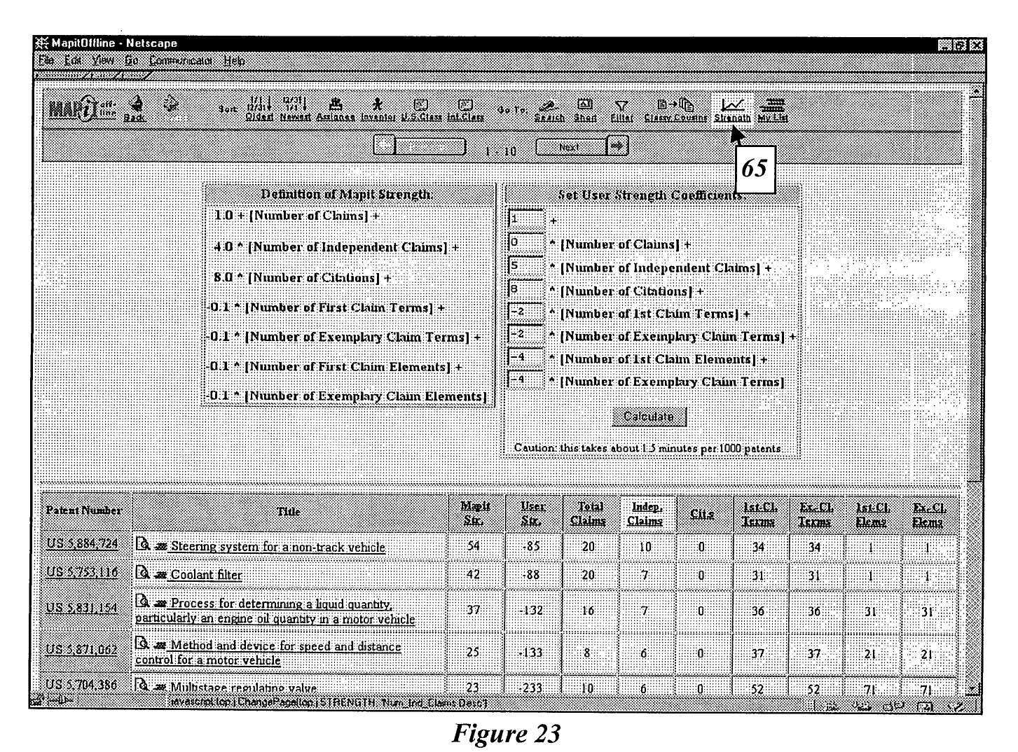

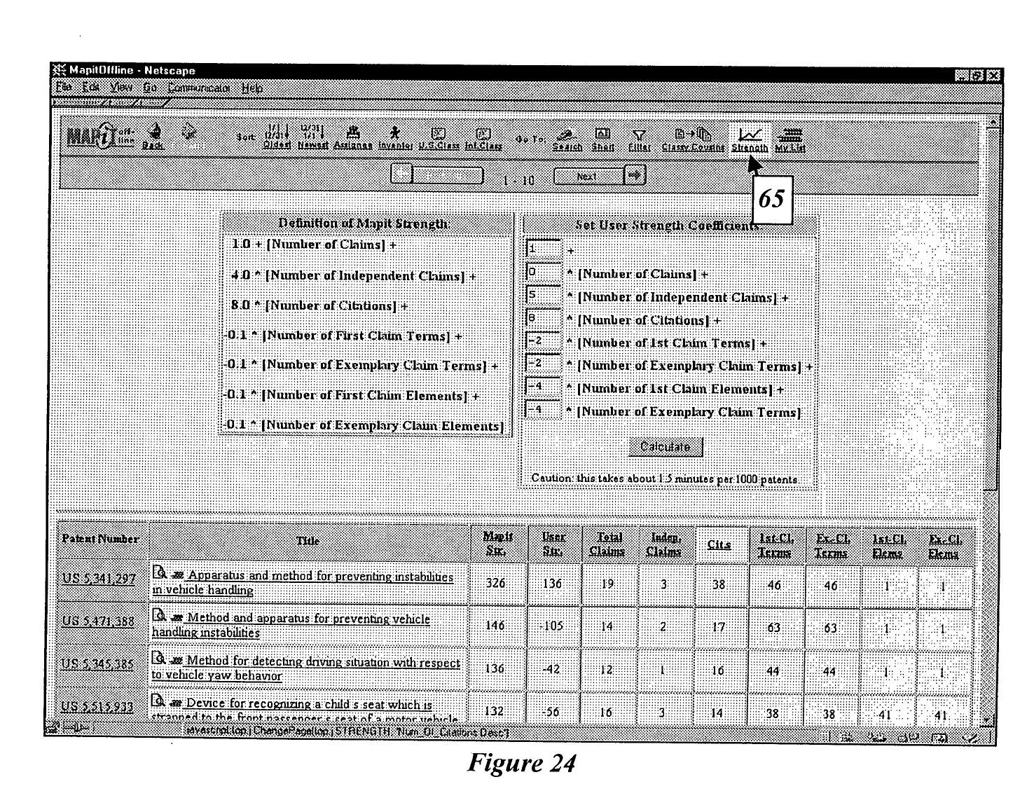

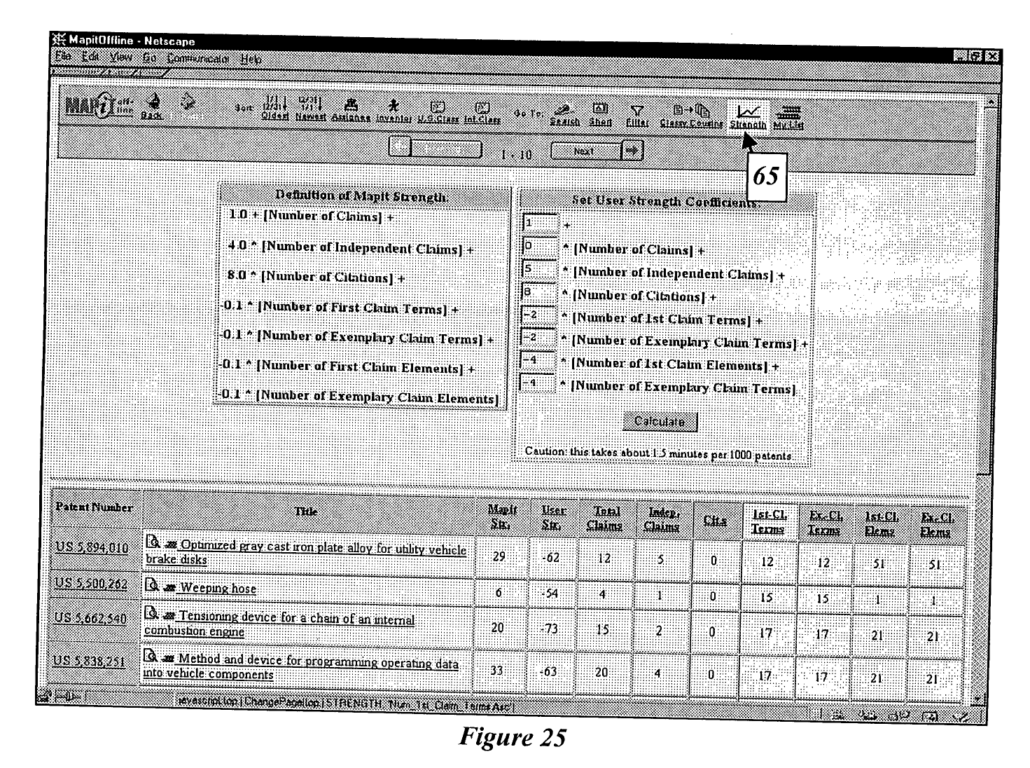

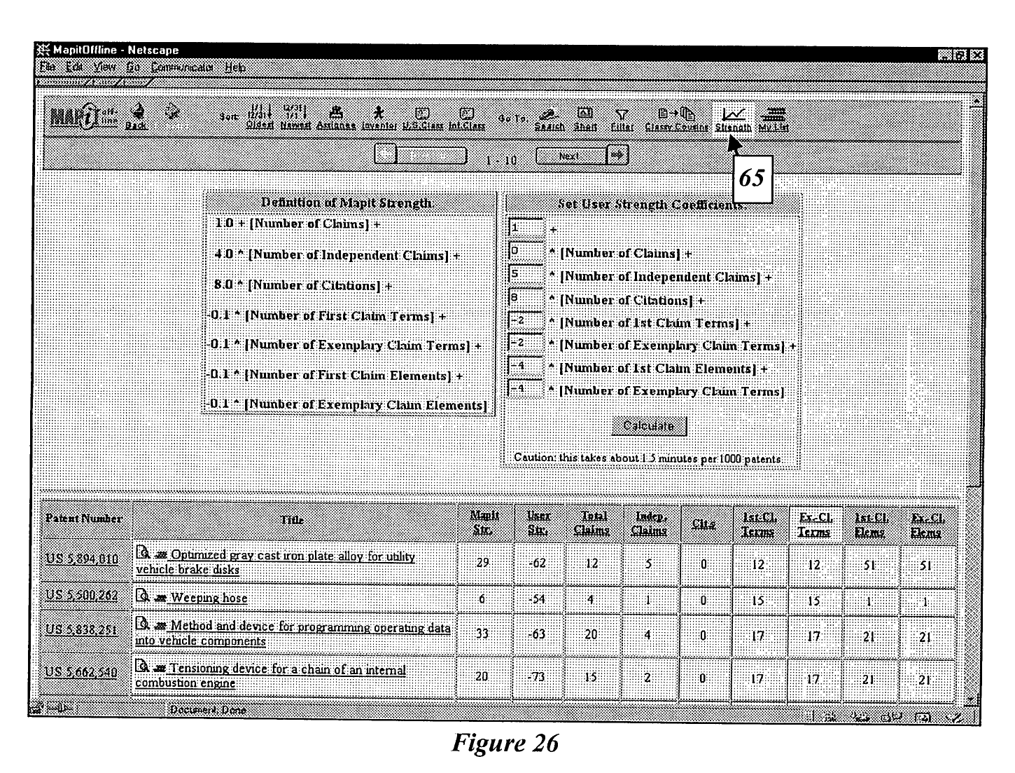

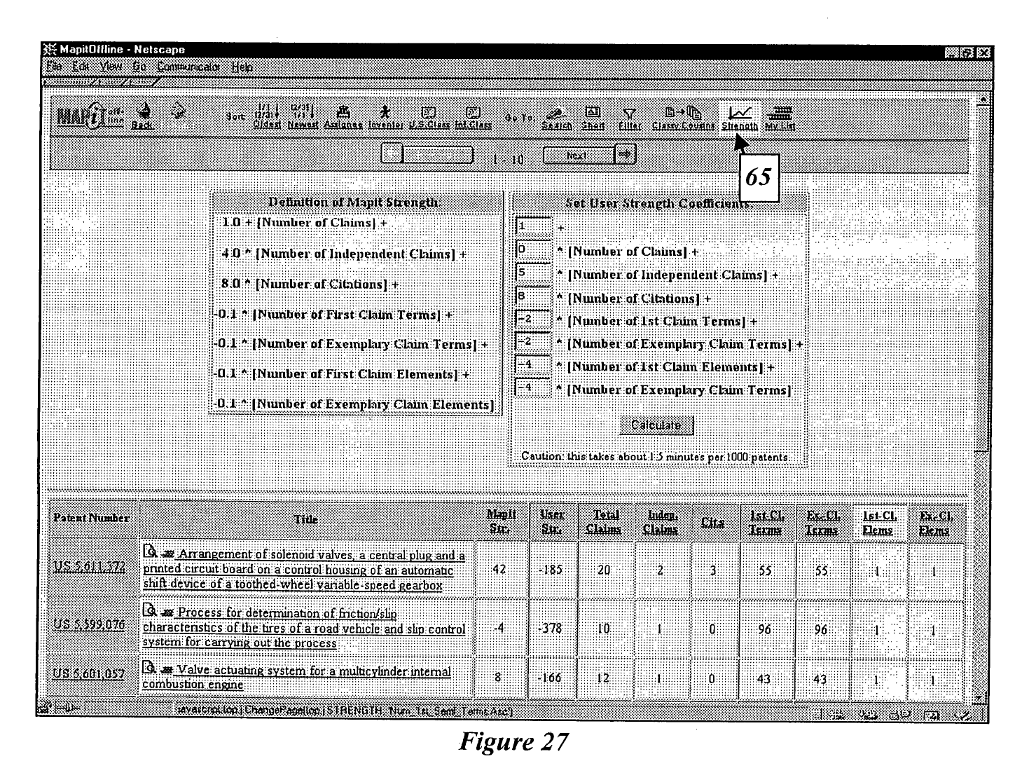

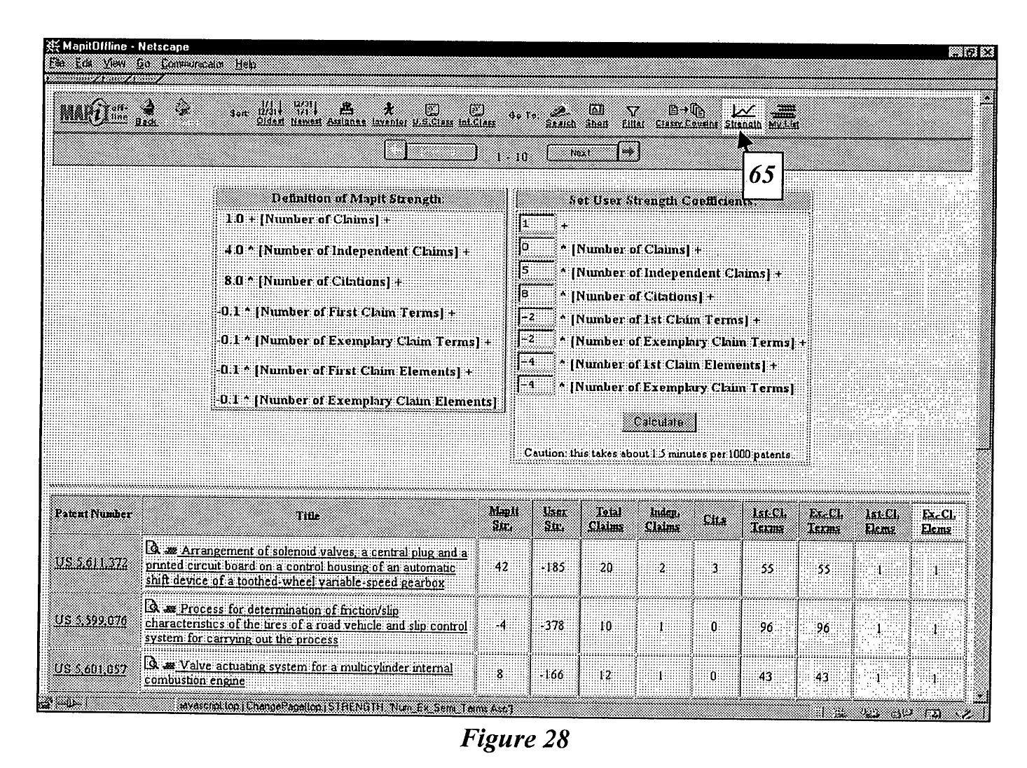

It is also possible to display the ranked patents in order according to any of the factors in the formula. For example, FIG. 22 lists the patents in descending order according to total number of claims. FIG. 23 lists the patents in descending order according to number of independent claims. FIG. 24 lists the patents in descending order according to the number of citations appearing on the face of the patent. FIG. 25 lists the patents in ascending order according to the number of search terms in the first claim of the patent. FIG. 26 lists the patents in ascending order according to the number of search terms in the exemplary claim of the patent. FIG. 27 lists the patents in ascending order according to the number of elements in the first claim of the patent. FIG. 28 lists the patents in ascending order according to the number of elements in the exemplary claim of the patent.

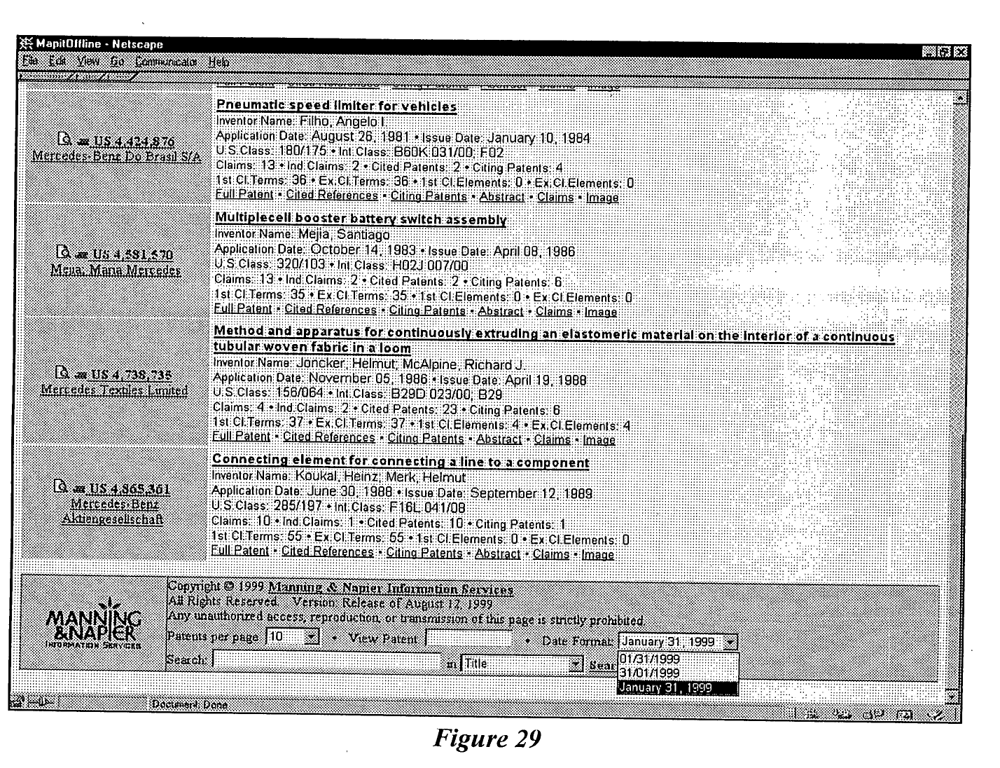

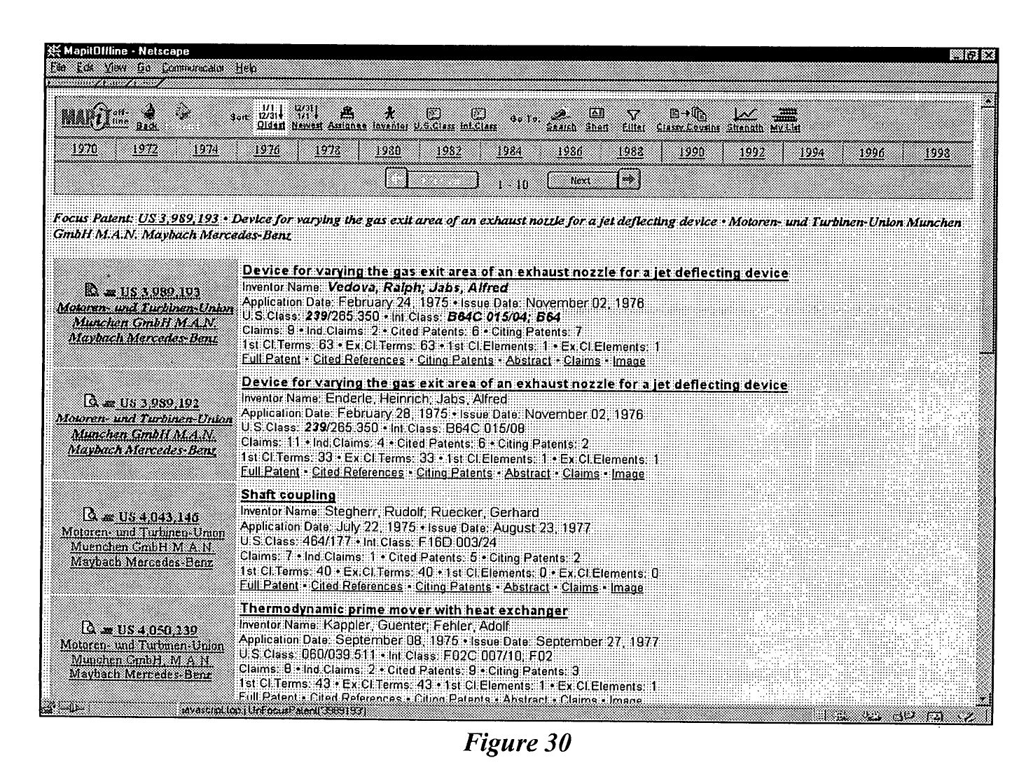

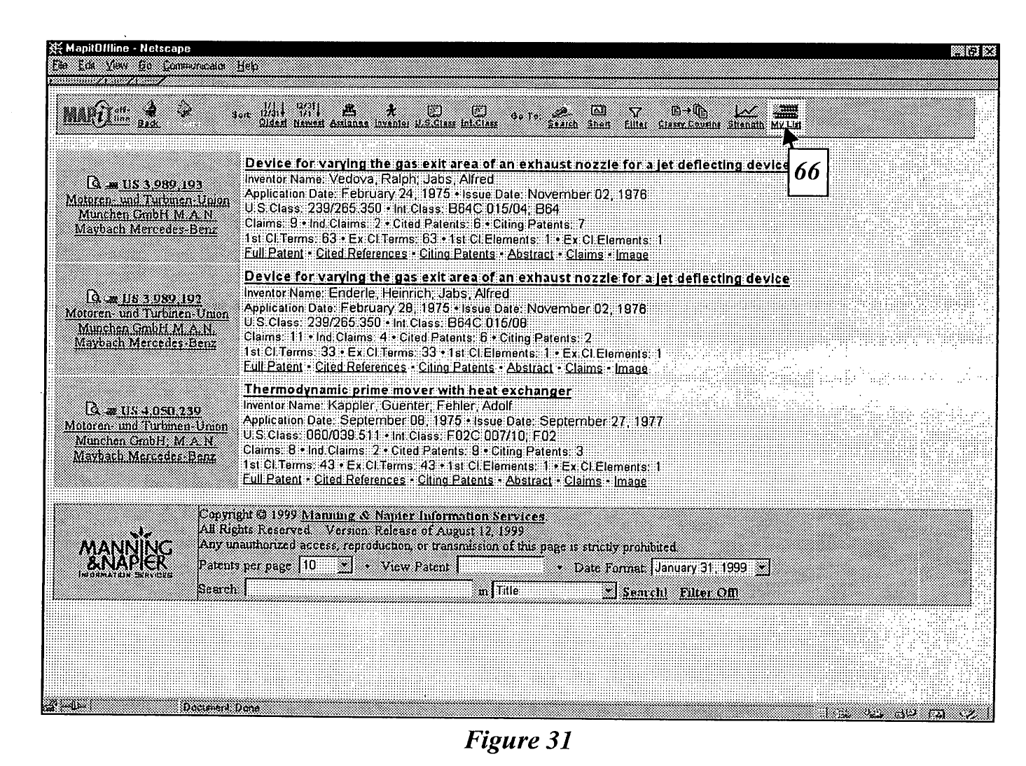

As mentioned previously, the software is compatible with various date formats, including American and European formats. As shown in the screen capture of FIG. 29, a drop-down box allows one to choose between short form mm/dd/yyyy or dd/mm/yyyy format, or a long-form format where the name of the month is displayed in full. The long form format is shown in the listing of patents in FIG. 30, and the date format box is shown completed as “Jan. 31, 1999” in FIG. 31.

The program determines the total number of claims in a patent under study by counting the number of “claims” rows in a database file. These electronic files are available directly from the United States Patent and Trademark Office. There are a number of ways in which the total number of claims can be determined. For example, one can simply identify the claim number at the beginning of each claim (while ignoring the claim number which appears in the body of dependent claims), and then count the total number of claims. Since each claim in a United States patent must necessarily comprise a single sentence, one can also count periods to determine the total number of claims. Additional parsing/counting clues can be obtained by looking for dependent claim language.

To determine whether a claim is independent or dependent in nature, the program looks for any conventional phrases used by practitioners to indicate claim dependency. Some of these phrases are suggested by the USPTO. Some examples include “claim N,” “claims N-M, and O-P,” “claims N through M, inclusive,” or “any previous claims” where N, M, 0, and P are numbers. The program accommodates for capitalization (e.g., “claim” or “claim”) and common misspellings (e.g., “Clam” instead of “claim”). In many cases, it is sufficient to merely search for the word “claim” in a patent claim—if this word appears, the claim under study is likely dependent in nature.

There are several different methods used to determine the total number of elements in a claim under study. The following are four examples of how the program determines the number of elements in a claim:

1. Look for clauses or phrases, and count these as elements;

2. Look for ordinal notation (“a, b, c” or “1, 2, 3”, or bulleted lists, etc.) and use this information to count elements;

3. Analyze punctuation such as semicolons, commas, parentheses, brackets, dashes or quotation marks, which may indicate element boundaries. For example, since all claims comprise a single sentence, practitioners commonly separate claim elements by semi-colons.

Another metric relates to a weighted count of linguistic or textual components found in the claim(s) under study or of correlations among such components. These components may be determined via analysis at various linguistic levels, including phonological, morphological, lexical, syntactic, semantic, discourse structure, or pragmatic levels.

For example, discourse structure of patents can be leveraged in the case of “means” language or specification-level definitions leveraged in the claims. The number of distinct semantic notions (at a particular level of a semantic hierarchy) could also be counted; semantic notions at different levels could instead receive different weights. Another example in this continuum is to count the number of nominal and verbal phrases or terms and combine this with information regarding counts and positions of modifiers such as adjectives, adverbs, and modifying phrases (e.g. prepositional phrases) or terms. Symbolic and formatting information can also be leveraged; punctuation, horizontal or vertical spacing, and ordinal information representations are some examples.

One simple approach is to count the number of “terms” in the claim or claims. A term, generically, is a string of characters, letters, numbers, symbols, or combinations thereof. Various levels of normalization may or may not be applied to the terms. Examples of these follow:

1. The program normalizes case of letters (e.g., uppercase all letters);

2. The program “stems” the terms, removing some or all suffixes and/or prefixes and obtains a “root” of the term;

3. The program removes non-unique occurrences of terms. This can be accomplished across the entire claim, or just within certain phrases. This can alternatively be applied only in cases where the terms “said” or “the” or other textual clues link the multiple occurrences (in patent claims, the words “said” or “the” preceding a noun usually means that the noun was mentioned previously, i.e., has an antecedent basis);

4. The program weights occurrences of different terms differently and may use a stop-word list to provide a weight of zero to certain terms.

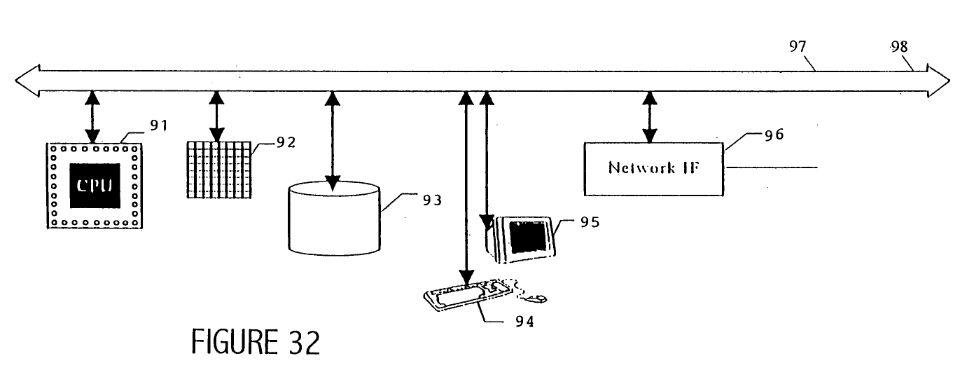

FIG. 32 illustrates one embodiment of an apparatus operatively arranged to implement and run the computer program of the present invention. The apparatus is seen to include a special purpose computer programmed to perform the program disclosed in the microfiche appendix. The computer comprises central processing unit (CPU) 91, random access memory (RAM) 92, hard disk storage drive 93, keyboard 94, monitor 95, and network interface 96. All of these components communicate with one another via communication bus 97. The computer may be a stand-alone personal computer, or a client or server computer on a network. It may also be a mainframe computer. The computer program of the invention, a source code listing of which is attached in the microfiche appendix, may be contained on hard drive 93, or on any suitable storage medium, such as a CD ROM, magnetic tape, optical drive, or floppy disk.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A computer based method for mining data from a patent-related document and displaying said data, comprising the steps of
analyzing each claim of said patent-related document; and,
determining how many elements are present in each claim; and,
displaying said data in a manner, which identifies the number of elements in each claim in said patent-related document.

2. A computer based method for mining data from a patent-related document and displaying said data as recited in claim 1, wherein each claim may contain semicolon(s), and wherein said step of determining how many elements are present in each claim comprises the step of counting the number of semicolons, if any, present in each claim, where the number of elements in said claim is related to the number of semicolons present in each claim.

3. A computer based method for mining data from a patent-related document as recited in claim 2 wherein the number of elements present in each claim is determined by counting the number of semicolons, if any, present in each claim, and then adding the number one to the number of semicolons.

4. A computer based method for mining data from a patent-related document and displaying said data as recited in claim 2 wherein said step of determining how many elements are present in each claim comprises the step of determining if each claim contains a sequence of ordered phrases, each said phrase identified by a letter or numeral.

5. A computer based method for mining data from a patent-related document and displaying said data comprising the steps of
identifying a preamble section of each claim in said patent-related document;
analyzing said preamble section of each claim to determine a type of invention being claimed; and,
displaying said type of invention to which the patent-related document is directed.

6. A computer based method for mining data from a patent-related document as recited in claim 5 wherein said type of invention is selected from the group consisting of article of manufacture, apparatus, method, design, plant, process, and improvement.

7. A computer based method for mining data from a patent-related document and displaying said data comprising the steps of
analyzing said patent-related document to determine how many citations to prior publications are included within said patent-related document; and,
displaying said number of citations.

8. A computer based method for determining the strength of a patent, comprising:
analyzing said patent to determine how many independent claims said patent includes; and,
assigning a strength value to said patent based upon said determination of number of independent claims.

9. A computer based method for determining the strength of a patent, comprising:
analyzing said patent to determine how many claims said patent includes; and,
assigning a strength value to said patent based upon said determination of number of claims.

10. A computer based method for determining the strength of a patent, comprising:
identifying an exemplary independent claim of said patent;
analyzing said exemplary independent claim of said patent to determine how many elements said exemplary independent claim includes, and,
assigning a strength value to said patent based upon said determination of number of elements in said exemplary independent claim.

11. A computer based method for determining the strength of a patent, comprising:
analyzing said patent document to determine how many citations to prior patent publications are included within said patent document; and,
assigning a strength value to said patent based upon said determination of number of citations to prior patent publications included within said patent document.

12. A computer based method for determining the strength of a patent, comprising:
analyzing said patent document to determine how many citations to prior non-patent publications are included within said patent document; and,
assigning a strength value to said patent based upon said determination of number of citations to prior non-patent publications included within said patent document.

13. A computer based method for determining the strength of a patent, comprising:
analyzing a set of other patent documents to determine how many patents in said set of other patent documents cite said patent, and,
assigning a strength value to said patent based upon said determination of how many patent documents cite said patent.

14. A computer based method for ranking a set of patents according to strength, comprising analyzing said set of patents by consideration of objective parameter(s) of each patent in said group, said parameter(s) selected from the group consisting of number of claims within patent, number of independent claims within patent, number of citations to prior publications within each patent cited by a patent examiner, number of other patents which contain a citation to each said patent, number of patents owned by others which contain a citation to each said patent, number of elements in an independent claim of each said patent, and number of elements in an exemplary claim of each said patent, and number of linguistic or textual components in said patent.

15. A computer based method for ranking a set of patents according to strength as recited in claim 14 further comprising the step of displaying said set of patents according to strength.

16. A computer based method for ranking a set of patents according to strength as recited in claim 14 wherein said analysis of said set of patents uses a formula which assigns a weight to each of said selected objective parameters.

17. A computer based method for ranking a set of patents according to strength as recited in claim 16 wherein said weights may be positive or negative and are settable by a user of said computer based method.

18. An apparatus for mining data from a patent-related document and displaying said data, comprising: means for analyzing each claim of said patent-related document; and, means for determining how many elements are present in each claim; and, means for displaying said data in a manner, which identifies the number of elements in each claim in said patent-related document.

19. An apparatus for mining data from a patent-related document as recited in claim 18 wherein said means for analyzing each claim of said patent-related document comprises a special purpose computer arranged to run a computer program.

20. An apparatus for mining data from a patent-related document as recited in claim 18 wherein said means for determining how many elements are present in each claim comprises a special purpose computer arranged to run a computer program.

21. An apparatus for mining data from a patent-related document as recited in claim 18 wherein said means for determining means for displaying said data in a manner, which identifies the number of elements in each claim in said patent-related document comprises a special purpose computer arranged to run a computer program.

22. An apparatus for ranking a set of patents according to strength, comprising means for analyzing said set of patents by consideration of objective parameter(s) of each patent in said group, said parameter(s) selected from the group consisting of number of claims within patent, number of independent claims within patent, number of citations to prior publications within each patent cited by a patent examiner, number of other patents which contain a citation to each said patent, number of patents owned by others which contain a citation to each said patent, number of elements in an independent claim of each said patent, and number of elements in an exemplary claim of each said patent, and number of linguistic or textual components in said patent.

23. An apparatus for ranking a set of patent according to strength as recited in claim 22 wherein said apparatus comprises a special purpose computer programmed to run a computer program.
